(19) United States
(12) Patent Application Publication
(10) Pub. No.: US 2026/0065932 A1
(43) Pub. Date: Mar. 5, 2026

(54) MAGNETIC RECORDING MEDIUM

(71) Applicant: Sony Group Corporation, Tokyo (JP)

(72) Inventors: Taiki KAWAGUCHI, Tokyo (JP); Masaru TERAKAWA, Tokyo (JP); Minoru YAMAGA, Tokyo (JP)

(21) Appl. No.: 18/847,335

(22) PCT Filed: Mar. 9, 2023
(86) PCT No.: PCT/JP2023/009032

§ 371 Date: Apr. 28, 2025

(30) Foreign Application Priority Data
Mar. 30, 2022 (JP) 2022-055010

(51) Int. Cl. G11B 5/708; G11B 5/78; G11B 23/037

(52) U.S. Cl. CPC G11B 5/708; G11B 5/78; G11B 23/037

(57) ABSTRACT

It is a main object to provide a magnetic recording medium having excellent electromagnetic conversion characteristics.

The present technology provides a magnetic recording medium having a layer structure, including: a magnetic layer and a base layer, in which the magnetic layer includes an alumina particle, a surface roughness Rab (a measurement range: 236 μm×177 μm) is 1.70 nm or less, an arithmetic average roughness Ra (a measurement range: 40 μm×40 μm) is 1.79 nm or less, or a power spectrum density (PSD) value at a spatial wavelength of 5 μm or less is 3.77 nm² or less, and an average height of a protrusion formed by the alumina particle is 0.0067 μm or less.

### TECHNICAL FIELD

The present technology relates to a magnetic recording medium.

### BACKGROUND ART

For example, with the development of IoT, big data, and artificial intelligence, the amount of data to be collected and stored has increased significantly. A magnetic recording medium is often used as a medium for recording a large amount of data.

With respect to a magnetic recording medium, various technologies have been proposed so far. For example, as a technology for improving travelling stability, the following Patent Literature 1 discloses a magnetic recording tape that has a multi-layer structure including at least a magnetic layer, in which the total thickness of the tape is 5.6 μm or less, a plurality of recessed portions is disposed on the surface of the magnetic layer, a value obtained by dividing a depth D1 of the recessed portion by a thickness D2 of the magnetic layer is 15% or more, the magnetic layer is perpendicularly oriented, the degree of perpendicular orientation without demagnetizing field correction is 65% or more, a plurality of recessed portions having a thickness of 20% or more of the thickness of the magnetic layer is formed in the magnetic layer, and the number of recessed portions is 55 or more per surface area of 6,400 μm² of the magnetic layer.

### CITATION LIST

### Patent Literature

Patent Literature 1: WO 2019/159465

### DISCLOSURE OF INVENTION

### Technical Problem

In recent years, magnetic tapes (magnetic recording media) have come to be used for archive purposes in data centers. In order to further increase the recording capacity of the magnetic recording medium, it is conceivable to make the total thickness of the magnetic recording medium thinner and increase the length of the magnetic recording medium per magnetic recording cartridge. However, when recording and/or reproduction is performed repeatedly, the surface condition of the magnetic recording medium whose total thickness is thin changes and the travelling stability deteriorates in some cases.

Further, while data tracs are becoming narrower as the capacity of magnetic recording media increases, it is undesirable for servo signals to be erroneously read. The increase in frictional force of the magnetic recording medium due to travelling of the magnetic recording medium many times can cause servo signals to be erroneously read, which is undesirable for magnetic recording.

Further, in the case where the frictional force of the magnetic recording medium is high, a stick-slip phenomenon occurs in some cases. The occurrence of the phenomenon can result in a deviation in the travelling speed of the magnetic recording medium. Further, due to the high frictional force, when the magnetic head is caused to move in the lateral direction in order to correct the servo position, the magnetic recording medium also moves, which can make it impossible to correct the servo position immediately.

In order to improve electromagnetic conversion characteristics, it is desired to suppress an increase in the frictional force of the magnetic recording medium and make the surface of the magnetic recording medium smooth.

The main object of the present technology is to provide a magnetic recording medium having excellent electromagnetic conversion characteristics.

### Solution to Problem

The present technology provides
a magnetic recording medium having a layer structure, including: a magnetic layer; and a base layer, in which
the magnetic layer includes an alumina particle,
a surface roughness Rab (a measurement range: 236 μm×177 μm) is 1.70 nm or less,
an arithmetic average roughness Ra (a measurement range: 40 μm×40 μm) is 1.79 nm or less, or
a power spectrum density (PSD) value at a spatial wavelength of 5 μm or less is 3.77 nm² or less, and
an average height of a protrusion formed by the alumina particle is 0.0067 μm or less.

The magnetic layer may further include a particle having conductivity.

The surface roughness Rab (a measurement range: 236 μm×177 μm) may be 1.67 nm or less.

The arithmetic average roughness Ra (a measurement range: 40 μm×40 μm) may be 1.73 nm or less.

The power spectrum density (PSD) value at a spatial wavelength of 5 μm or less may be 3.48 nm² or less.

The average height of a protrusion formed by the alumina particle may be 0.0060 μm or less.

An average thickness of the magnetic layer may be 0.09 μm or less.

The magnetic recording medium according to the present technology may further include a non-magnetic layer.

An average thickness of the non-magnetic layer may be 1.3 μm or less.

The magnetic recording medium may have an average thickness (average total thickness) of 5.9 μm or less.

The present technology provides a magnetic recording cartridge, including: the magnetic recording medium housed in a case while being wound around a reel.

### BRIEF DESCRIPTION OF DRAWINGS

FIG. 1 is a cross-sectional view showing a configuration of a magnetic recording medium according to a first embodiment.

FIG. 2 is a schematic diagram showing a configuration of a recording/reproduction apparatus.

FIG. 3 is a cross-sectional view showing a configuration of a magnetic recording medium according to a modified example.

FIG. 4 is an exploded perspective view showing an example of a configuration of a magnetic recording cartridge.

FIG. 5 is a block diagram showing an example of a configuration of a cartridge memory.

FIG. 6 is an exploded perspective view showing an example of a configuration of a magnetic recording cartridge according to a modified example.

FIG. 7 is an image showing an example of a surface shape imaged by an AFM.

FIG. 8 is a diagram showing an example of a protrusion analysis result by the AFM.

FIG. 9 is a diagram showing an example of a protrusion height distribution by the AFM.

FIG. 10 is an example of an FE-SEM image.

FIG. 11 is a composite image obtained by overlaying an AFM image and an FE-SEM image.

FIG. 12 is an enlarged view of the composite image obtained by overlaying an AFM image and an FE-SEM image.

FIG. 13 is a diagram showing an example of an analysis result by the AFM for a line 1 Line1) in FIG. 12.

FIG. 14 is a diagram showing a cumulative frequency distribution of heights of protrusions formed by second particles (alumina particles).

FIG. 15 is a diagram showing an example of a shape of a particle of a magnetic powder.

FIG. 16 shows an example of a TEM photograph of a sample cross section.

FIG. 17 shows another example of a TEM photograph of a sample cross section.

### MODE(S) FOR CARRYING OUT THE INVENTION

Hereinafter, suitable embodiments for carrying out the present technology will be described. Note that the embodiments described below show typical embodiments of the present technology, and the scope of the present technology is not limited only to these embodiments.

The present technology will be described in the following order.
1. Description of present technology
2. First Embodiment
(1) Configuration of magnetic recording medium
(2) Description of each layer
(3) Physical properties and structure
(4) Method of producing magnetic recording medium
(5) Recording/reproduction apparatus
(6) Modified example
3. Second embodiment (cartridge)
(1) Embodiment of magnetic recording cartridge
(2) Modified example of magnetic recording cartridge
4. Examples

In the present specification, unless a measurement environment is specifically stated regarding description of a measurement method, measurement is performed in an environment of 25° C.±2° C. and 50% RH±5% RH.

### 1. Description of Present Technology

The present inventors have changed the size of an alumina particle forming a protrusion on the surface layer of a magnetic recording medium and found a high correlation with electromagnetic conversion characteristics using surface properties in a wide range of the magnetic recording medium, surface properties in a narrow range, and a height of a protrusion formed by the alumina particle on the surface layer of the magnetic recording medium as indices.

That is, the magnetic recording medium according to the present technology has a layer structure, including: a magnetic layer; and a base layer. The magnetic layer includes an alumina particle.

The magnetic recording medium may have a surface roughness Rab (a measurement range: 236 μm×177 μm) of 1.70 nm or less, favorably 1.67 nm or less, more favorably 1.64 nm or less, and still more favorably 1.61 nm or less. A method of measuring the roughness Rab (a measurement range: 236 μm×177 μm) will be described in the following 2. (3). When the magnetic recording medium has the surface roughness Rab within the above numerical range, the surface is smooth, which contributes to improving electromagnetic conversion characteristics.

The magnetic recording medium may have an arithmetic average roughness Ra (a measurement range: 40 μm×40 μm) of 1.79 nm or less, favorably 1.73 nm or less, more favorably 1.64 nm or less, and still more favorably 1.59 nm or less. A method of measuring the arithmetic average roughness Ra (a measurement range: 40 μm×40 μm) will be described in the following 2. (3). When the magnetic recording medium has the arithmetic average roughness Ra within the above numerical range, the surface is smooth, which contributes to improving electromagnetic conversion characteristics.

The magnetic recording medium may have a power spectrum density (PSD) value at a spatial wavelength of 5 μm or less of 3.77 nm² or less, favorably 3.48 nm² or less, more favorably 3.15 nm² or less, and still more favorably 2.95 nm² or less. A method of measuring the power spectrum density (PSD) value at a spatial wavelength of 5 μm or less will be described in the following 2. (3).

The magnetic recording medium may have an average height of a protrusion formed by the alumina particle of 0.0067 μm or less, favorably 0.0060 μm or less, more favorably 0.0057 μm or less, and still more favorably 0.0050 μm or less. A method of measuring the average height of a protrusion formed by the alumina particle will be described in the following 2. (3).

The magnetic recording medium according to the present technology is favorably a long magnetic recording medium and may be, for example, a magnetic recording tape (particularly, a long magnetic recording tape).

The magnetic recording medium according to the present technology may include a magnetic layer, a non-magnetic layer (underlayer), a base layer, and a back layer in this order, and may include a different layer in addition to these layers. The different layer may be appropriately selected in accordance with the type of magnetic recording medium. The magnetic recording medium is a coating type magnetic recording medium. For layers included in the magnetic recording medium other than the above four layers, description of the layers should be referred to.

An average thickness (average total thickness) t_{T} of the magnetic recording medium according to the present technology may be, for example, favorably 5.9 μm or less, more favorably 5.8 μm or less, and still more favorably 5.7 μm or less. Since the magnetic recording medium is thin like this, for example, it is possible to make the length of the tape wound up in one magnetic recording cartridge longer and thus increase the recording capacity per magnetic recording cartridge. The lower limit value of the average thickness (average total thickness) tr of the magnetic recording medium is not particularly limited, but satisfies the following relationship: for example, 3.5 μm≤t_{T}.

An average thickness tₘ of the magnetic layer of the magnetic recording medium according to the present technology may be favorably 0.09 μm or less, more favorably 0.08 μm or less, still more favorably 0.07 μm or less, and still more favorably 0.06 μm or less. The lower limit value of the average thickness tₘ of the magnetic layer is not particularly limited, but may be favorably 0.03 μm or more. A method of measuring the average thickness of the magnetic layer will be described in the following 2. (3).

An average thickness of the non-magnetic layer (average thickness of the underlayer) of the magnetic recording medium according to the present technology may be favorably 1.3 μm or less, more favorably 1.2 μm or less, and still more favorably 1.0 μm or less. Further, the lower limit value of the average thickness of the non-magnetic layer is not particularly limited, but may be favorably 0.2 μm or more, more favorably 0.3 μm or more. A method of measuring the average thickness of the non-magnetic layer will be described in the following 2. (3).

The average thickness of the base layer of the magnetic recording medium according to the present technology may be favorably 4.5 μm or less, more favorably 4.2 μm or less, 4.0 μm or less, 3.6 μm or less, and still more favorably 3.0 μm or less. A method of measuring the average thickness of the base layer will be described in the following 2. (3).

The average thickness of the back layer of the magnetic recording medium according to the present technology may be favorably 0.6 μm or less, more favorably 0.5 μm or less, and still more favorably 0.4 μm or less, 0.3 μm or less, 0.25 μm or less, or 0.2 μm or less. A method of measuring the average thickness of the back layer will be described in the following 2. (3).

An average particle volume of a magnetic powder included in the magnetic recording medium according to the present technology may be 2600 nm³ or less, favorably 2000 nm³ or less, and more favorably 1600 nm³ or less. When the average particle volume is within the above numerical range, the electromagnetic conversion characteristics are improved. Although the average particle volume of a magnetic powder included in the magnetic recording medium according to the present technology is very small like this, the magnetic recording medium according to the present technology has excellent thermal stability as described above. While it is difficult to achieve both electromagnetic conversion characteristics and thermal stability, the present technology makes it possible to improve both electromagnetic conversion characteristics and thermal stability. The average particle volume of the magnetic powder may be, for example, 500 nm³ or more, particularly 700 nm³ or more. A method of measuring the average particle volume of the magnetic powder will be described in the following 2. (3).

In the present technology, a squareness ratio in the perpendicular direction may be favorably 65% or more, more favorably 67% or more, and still more favorably 70% or more. When the squareness ratio is within the above numerical range, the perpendicularly orientation of the magnetic powder is sufficiently high, and thus, more excellent CNR can be achieved. Therefore, it is possible to achieve more excellent electromagnetic conversion characteristics. A method of measuring the squareness ratio in the perpendicular direction will be described in the following 2. (3).

The magnetic recording medium according to the present technology may include, for example, at least one data band and at least two servo bands. The number of data bands may be, for example, 2 to 10, particularly 3 to 6, and more particularly 4 or 5. The number of servo bands may be, for example, 3 to 11, particularly 4 to 7, and more particularly 5 or 6. The servo band and the data band may be disposed so as to extend in, for example, the longitudinal direction of a long magnetic recording medium (particularly, magnetic recording tape), particularly so as to be substantially parallel. The data band and the servo band may be provided in the magnetic layer. Examples of the magnetic recording medium that includes a data band and a servo band include a magnetic recording tape conforming to the LTO (Linear Tape-Open) standard. That is, the magnetic recording medium according to the present technology may be a magnetic recording tape according to the LTO standard. For example, the magnetic recording medium according to the present technology may be a magnetic recording tape conforming to the standard of LTO8 or subsequent LTOs (e.g., LTO9, LTO10, LTO11, or LTO12).

The width of the long magnetic recording medium (particularly, magnetic recording tape) according to the present technology may be, for example, 5 mm to 30 mm, particularly 7 mm to 25 mm, more particularly 10 mm to 20 mm, and still more particularly 11 mm to 19 mm. The length of the long magnetic recording medium (particularly, magnetic recording tape) may be, for example, 500 m to 1500 m. For example, the tape width and the length conforming to the LTO8 standard are respectively 12.65 mm and 960 m.

### 2. First Embodiment

### (1) Configuration of Magnetic Recording Medium

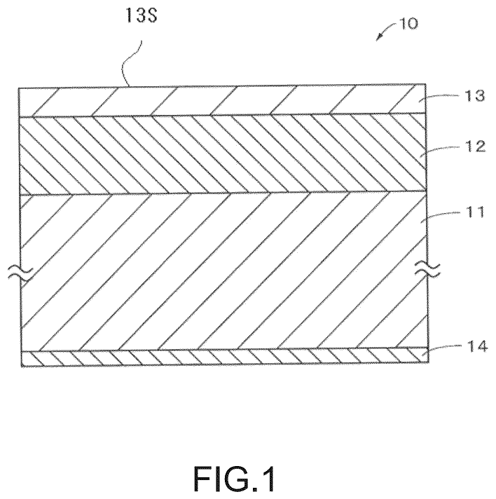

A configuration of a magnetic recording medium 10 according to a first embodiment will be described first with reference to FIG. 1. The magnetic recording medium 10 is, for example, a magnetic recording medium that has been subjected to perpendicular orientation processing and includes a long base layer (referred to also as a base) 11, a non-magnetic layer (referred to also as an underlayer) 12 provided on one main surface of the base layer 11, a magnetic layer (referred to also as a recording layer) 13 provided on the non-magnetic layer 12, and a back layer 14 provided on the other main surface of the base layer 11, as shown in FIG. 1. Hereinafter, of both main surfaces of the magnetic recording medium 10, the surface on the side where the magnetic layer 13 is provided will be referred to as a magnetic surface, and the surface on the side opposite to the magnetic surface (surface where the back layer 14 is provided) will be referred to as a back surface.

The magnetic recording medium 10 has a long shape and is caused to travel in the longitudinal direction during recording and reproduction. Further, the magnetic recording medium 10 may be configured to be capable of recording signals at the shortest recording wavelength of, favorably 100 nm or less, more favorably 75 nm or less, still more favorably 60 nm or less, and particularly favorably 50 nm or less, and may be used in, for example, a recording/reproduction apparatus having the shortest recording wavelength within the above range. This recording/reproduction apparatus may include a ring-type head as a recording head. The recording track width is, for example, 2 μm or less.

### (2) Description of Each Layer

### (Base Layer)

The base layer 11 may function as a support for the magnetic recording medium 10, and may be, for example, a long non-magnetic base having flexibility, particularly a non-magnetic film. The average thickness of the base layer 11 may be, for example, favorably 4.5 μm or less, more favorably 4.2 μm or less, 4.0 μm or less, 3.6 μm or less, and still more favorably 3.0 μm or less. Note that the lower limit of the average thickness of the base layer 11 may be determined, for example, from the viewpoint of the limitation of the film deposition or the function of the base layer 11. The base layer 11 may contain, for example, at least one of a polyester resin, a polyolefin resin, a cellulose derivative, a vinyl resin, an aromatic polyetherketone resin, or a different polymer resin. In the case where the base layer 11 contains two or more of the above materials, the two or more materials may be mixed, copolymerized, or stacked.

The polyester resin may be, for example, one of PET (polyethylene terephthalate), PEN (polyethylene naphthalate), PBT (polybutylene terephthalate), PBN (polybutylene naphthalate), PCT (polycyclohexylene dimethylene terephthalate), PEB (polyethylene-p-oxybenzoate), and polyethylene bisphenoxycarboxylate, or a mixture of two or more thereof. The base layer 11 may be formed of PET or PEN in accordance with a favorable aspect of the present technology.

The polyolefin resin may be, for example, one of PE (polyethylene) and PP (polypropylene), or a mixture of two or more thereof.

The cellulose derivative may be, for example, one of cellulose diacetate, cellulose triacetate, CAB (cellulose acetate butyrate), and CAP (cellulose acetate propionate), or a mixture of two or more thereof.

The vinyl resin may be, for example, one of PVC (polyvinyl chloride) and PVDC (polyvinylidene chloride), or a mixture of two or more thereof.

The aromatic polyetherketone resin may be, for example, one of PEK (polyetherketone), PEEK (polyetheretherketone), PEKK (polyetherketoneketone), and PEEKK (polyetheretherketoneketone), or a mixture of two or more thereof. The base layer 11 may be formed of PEEK in accordance with a favorable aspect of the present technology.

The different polymer resin may be, for example, one of PA (polyamide, nylon), aromatic PA (aromatic polyamide, aramid), PI (polyimide), aromatic PI (aromatic polyimide), PAI (polyamideimide), aromatic PAI (aromatic polyamideimide), PBO (polybenzoxazole, e.g., Zylon (registered trademark)), polyether, polyetherester, PES (polyethersulfone), PEI (polyetherimide), PSF (polysulfone), PPS (polyphenylene sulfide), PC (polycarbonate), PAR (polyarylate), and PU (polyurethane), or a mixture of two or more thereof.

### (Magnetic Layer)

The magnetic layer 13 may be, for example, a perpendicular recording layer. The magnetic layer 13 includes a magnetic powder. The magnetic layer 13 includes an alumina particle and a particle having conductivity, in addition to the magnetic powder. Further, the magnetic layer 13 may further include, for example, a binder. The magnetic layer 13 may further include, as necessary, an additive such as a lubricant and a rust inhibitor.

The average thickness tₘ of the magnetic layer 13 may be favorably 0.09 μm or less, more favorably 0.08 μm or less, still more favorably 0.07 μm or less, and still more favorably 0.06 μm or less. The lower limit value of the average thickness tₘ of the magnetic layer 13 is not particularly limited, but may be favorably 0.03 μm or more. The average thickness tₘ of the magnetic layer 13 within the above numerical range contributes to improving the electromagnetic conversion characteristics.

The magnetic layer 13 is favorably a perpendicularly oriented magnetic layer. In the present specification, the term “perpendicularly oriented” means that a squareness ratio S1 measured in the longitudinal direction of the magnetic recording medium 10 (travelling direction) is 35% or less.

Note that the magnetic layer 13 may be an in-plane oriented (longitudinally oriented) magnetic layer. That is, the magnetic recording medium 10 may be a longitudinal recording magnetic recording medium. However, from the viewpoint of achieving high recording density, it is more favorably perpendicularly oriented.

### (Magnetic Powder)

Examples of the magnetic particle forming the magnetic powder included in the magnetic layer 13 include, but not limited to, epsilon-type iron oxide (ε-iron oxide), gamma hematite, magnetite, chromium dioxide, cobalt-coated iron oxide, hexagonal ferrite, barium ferrite (BaFe), Co ferrite, strontium ferrite, and metal. The magnetic powder may be one of these, or may be a combination of two or more of them. Particularly favorably, the magnetic powder may include an ε-iron oxide magnetic powder, a barium ferrite magnetic powder, a cobalt ferrite magnetic powder, or a strontium ferrite magnetic powder. Note that ε-iron oxide may contain Ga and/or Al. These magnetic particles may be appropriately selected by those skilled in the art on the basis of the factors such as the method of producing the magnetic layer 13, the tape standard, and the tape function.

An average particle size (average maximum particle size) D of the magnetic powder may be favorably 22 nm or less, more favorably 8 nm or more and 22 nm or less, and still more favorably 10 nm or more and 20 nm or less.

The above average particle size D of the magnetic powder is obtained as follows. First, the magnetic recording medium 10 to be measured is processed by an FIB (Focused Ion Beam) method or the like to prepare a slice, and the cross section of the slice is observed by a TEM. Next, 500 ε-iron oxide particles are selected randomly from the taken TEM photograph, and a maximum particle size dₘₐₓ of each particle is measured to obtain the granularity distribution of the maximum particle size dₘₐₓ of the magnetic powder. Here, the “maximum particle size dₘₐₓ” means a so-called maximum Feret diameter, and specifically refers to the largest one of the distances between two parallel lines drawn from all angles so as to be in contact with the contour of the ε-iron oxide particle. After that, a median diameter (50% diameter, D50) of the maximum particle size dₘₐₓ is obtained on the basis of the obtained granularity distribution of the maximum particle size dₘₐₓ and used as the average particle size (average maximum particle size) D of the magnetic powder.

The shape of the magnetic powder is favorably at least one of a plate shape, a spherical shape, or a rectangular shape. The shape of the magnetic powder depends on the crystal structure of the magnetic particle. Examples of the magnetic powder having a plate shape include BaFe and strontium ferrite having a hexagonal plate shape. Examples of the magnetic powder having a spherical shape include ε-iron oxide. Examples of the magnetic powder having a rectangular shape include cobalt ferrite having a cubic shape. These magnetic particles are oriented in the process of producing the magnetic recording medium 10.

In accordance with a favorable aspect of the present technology, the magnetic powder may include favorably a powder of nanoparticles containing ε-iron oxide (hereinafter, referred to as “ε-iron oxide particles”.). The ε-iron oxide particles are capable of achieving a high coercive force even if the ε-iron oxide particles are fine particles. The ε-iron oxide contained in the ε-iron oxide particles is favorably crystal-oriented preferentially in the thickness direction (perpendicular direction) of the magnetic recording medium 10.

The ε-iron oxide particles each have a spherical shape or a substantially spherical shape, or each have a cubic shape or a substantially cubic shape. Since the ε-iron oxide particles have the above shapes, in the case where ε-iron oxide particles are used as the magnetic particles, the area of contact between the particles in the thickness direction of the medium can be reduced and the aggregation of the particles can be suppressed as compared with the case of using hexagonal plate-shaped barium ferrite particles as the magnetic particles. Therefore, it is possible to increase the dispersibility of the magnetic powder and achieve a more favorable SNR (Signal-to-Noise Ratio).

The ε-iron oxide particles each have a core-shell structure or a Janus structure. Specifically, the ε-iron oxide particles each include a core portion, and a shell portion that has a two-layer structure and is provided around the core portion. The shell portion having the two-layer structure includes a first shell portion provided on the core portion and a second shell portion provided on the first shell portion. In the present technology, the surface activity of the magnetic powder may be controlled using the core-shell structure to suppress the capture of fatty acids.

The core portion contains ε-iron oxide. The ε-iron oxide contained in the core portion favorably has ε-Fe₂O₃ crystal as the main phase, and has more favorably a single phase of ε-Fe₂O₃.

The first shell portion covers at least a part of the periphery of the core portion. Specifically, the first shell portion may partially cover the periphery of the core portion or may cover the entire periphery of the core portion. It is favorable that the first shell portion covers the entire surface of the core portion from the viewpoint of making the exchange coupling between the core portion and the first shell portion sufficient and improving the magnetic characteristics.

The first shell portion is a so-called soft magnetic layer and may contain a soft magnetic material such as α-Fe, an Ni—Fe alloy, and an Fe—Si—Al alloy. α-Fe may be one obtained by reducing ε-iron oxide contained in the core portion.

The second shell portion is an oxide film as an antioxidant layer. The second shell portion may contain α-iron oxide, aluminum oxide, or silicon oxide. α-iron oxide may include, for example, at least one type of iron oxide of Fe₃O₄, Fe₂O₃, and FeO. In the case where the first shell portion contains α-Fe (soft magnetic material), the α-iron oxide may be one obtained by oxidizing α-Fe contained in the first shell portion.

When the ε-iron oxide particle includes the first shell portion as described above, it is possible to ensure thermal stability. As a result, it is possible to maintain a coercive force Hc of the core portion alone at a large value and/or adjust the coercive force Hc of the entire ε-iron oxide particles (core-shell particles) to the coercive force Hc suitable for recording. Further, when the &-iron oxide particle includes the second shell portion as described above, it is possible to suppress the deterioration of characteristics of the ε-iron oxide particles due to rust or the like generated on the particle surface by the ε-iron oxide particles exposed to air during and before the process of producing the magnetic recording medium 10. Therefore, it is possible to suppress the characteristic deterioration of the magnetic recording medium 10.

The ε-iron oxide particle may include a shell portion having a single-layer structure. In this case, the shell portion has a configuration similar to that of the first shell portion. However, from the viewpoint of suppressing the characteristic deterioration of the ε-iron oxide particles, it is more favorable that the ε-iron oxide particle includes a shell portion having a two-layer structure.

The ε-iron oxide particle may include an additive instead of the core-shell structure or may include an additive while having the core-shell structure. In these cases, some Fes of the ε-iron oxide particles are substituted with additives. Also when the ε-iron oxide particle includes an additive, the coercive force Hc of the entire ε-iron oxide particles can be adjusted to the coercive force Hc suitable for recording, and thus, the easiness of recording can be improved. The additive is a metal element other than iron, favorably a trivalent metal element, and more favorably one or more kinds selected from the group consisting of aluminum (Al), gallium (Ga), and indium (In).

Specifically, the ε-iron oxide including an additive is an ε-Fe₂₋ₓMₓO₃ crystal (where M represents a metal element other than iron, favorably a trivalent metal element, and more favorably one or more kinds selected from the group consisting of Al, Ga, and In. x satisfies the following relationship: 0<x<1, for example.).

In accordance with another favorable aspect of the present technology, the magnetic powder may be a barium ferrite (BaFe) magnetic powder. The barium ferrite magnetic powder includes magnetic particles of iron oxides having barium ferrite as a main phase (hereinafter, referred to as “barium ferrite particles”). The barium ferrite magnetic powder has high reliability in data recording, e.g., the coercive force does not decrease even in high-temperature and high-humidity environments. From this viewpoint, the barium ferrite magnetic powder is favorable as the above magnetic powder.

The average particle size of the barium ferrite magnetic powder may be 50 nm or less, more favorably 10 nm or more and 40 nm or less, and still more favorably 12 nm or more and 25 nm or less.

In the case where the magnetic layer 13 includes the barium ferrite magnetic powder as the magnetic powder, the average thickness tₘ [nm] of the magnetic layer 13 is favorably 0.09 μm or less, more favorably 0.08 μm or less, and still more favorably 0.07 μm or less. Further, the coercive force Hc measured in the thickness direction (perpendicular direction) of the magnetic recording medium 10 is favorably 160 kA/m or more and 280 kA/m or less, more favorably 165 kA/m or more and 275 kA/m or less, and still more favorably 170 kA/m or more and 270 kA/m or less.

In accordance with still another favorable aspect of the present technology, the magnetic powder may be a cobalt ferrite magnetic powder. The cobalt ferrite magnetic powder includes magnetic particles of iron oxides having cobalt ferrite as the main phase (hereinafter, referred to as “cobalt ferrite magnetic particles”.). The cobalt ferrite magnetic particles favorably have uniaxial anisotropy. The cobalt ferrite magnetic particles each have, for example, a cubic shape or a substantially cubic shape. The cobalt ferrite is cobalt ferrite containing Co. The cobalt ferrite may further contain one or more kinds selected from the group consisting of Ni, Mn, Al, Cu, and Zn, in addition to Co.

The Cobalt ferrite has, for example, the average composition represented by the following formula (1).

CoₓM_{y}Fe₂O_{z} (1)

(However, in the formula (1), M represents, for example, one or more metals selected from the group consisting of Ni, Mn, Al, Cu, and Zn. x represents a value within the range of 0.4≤x≤1.0. y represents a value within the range of 0≤y≤0.3. However, x and y satisfy the following relationship: (x+y)≤1.0. z represents a value within the range of 3≤z≤4. Some Fes may be substituted with another metal element.)

The average particle size of the cobalt ferrite magnetic powder may be favorably 25 nm or less, more favorably 23 nm or less. The coercive force Hc of the cobalt ferrite magnetic powder may be favorably 2500 Oe or more, more favorably 2600 Oe or more and 3500 Oe or less.

In accordance with still another favorable aspect of the present technology, the magnetic powder may include a powder of nanoparticles containing hexagonal ferrite (hereinafter, referred to as “hexagonal ferrite particles”.). The hexagonal ferrite particles each have, for example, a hexagonal plate shape or a substantially hexagonal plate shape. The hexagonal ferrite may contain favorably at least one of Ba, Sr, Pb, or Ca, more favorably at least one of Ba or Sr. Specifically, the hexagonal ferrite may be, for example, barium ferrite or strontium ferrite. Barium ferrite may further contain at least one of Sr, Pb, or Ca in addition to Ba. Strontium ferrite may further contain at least one of Ba, Pb, or Ca in addition to Sr.

More specifically, hexagonal ferrite may have an average composition represented by the general formula MFe₁₂O₁₉. Here, M presents, for example, at least one metal of Ba, Sr, Pb, or Ca, favorably at least one metal of Ba or Sr. M may be a combination of Ba and one or more metals selected from the group consisting of Sr, Pb, and Ca. Further, M may be a combination of Sr and one or more metals selected from the group consisting of Ba, Pb, and Ca. In the above general formula, some Fes may be substituted with another metal element.

In the case where the magnetic powder includes a powder of hexagonal ferrite particles, the average particle size of the magnetic powder may be favorably 50 nm or less, more favorably 10 nm or more and 40 nm or less, and still more favorably 15 nm or more and 30 nm or less.

### (Alumina Particles)

Examples of the alumina particles include α-Al₂O₃ (α-alumina) having an α transformation rate of 90% or more, β-Al₂O₃ (β-alumina), and γ-Al₂O₃ (γ-alumina). These alumina particles may have any shape such as a needle shape, a spherical shape, and a dice shape, but those with some corners in their shapes are favorable because they have high abrasiveness.

### (Average Height of Protrusion Formed by Alumina Particles)

The alumina particle forms a protrusion on the surface on the side of the magnetic layer.

The average height of a protrusion formed by the alumina particle may be 0.0067 μm or less, favorably 0.0060 μm or less, more favorably 0.0057 μm or less, and still more favorably 0.0050 μm or less.

When the magnetic recording medium has an average height (H₂) of the protrusion formed by the alumina particle within the above numerical range, it contributes to making it possible to reduce the spacing between the magnetic head and the magnetic recording medium, make the surface smooth, suppressing an increase in friction caused by travelling many times, maintain the polishing force on the magnetic head appropriately, and improve the electromagnetic conversion characteristics.

Further, the lower limit of the average height (H₂) of a protrusion formed by the alumina particle is not particularly limited, but may be, for example, favorably 2.0 nm or more, more favorably 2.5 nm or more, and still more favorably 3.0 nm or more.

### (Particle Having Conductivity)

As the particle having conductivity, a fine particle containing carbon as the main component can be used. For example, carbon particles may favorably be used. Examples of such carbon particles include carbon black. As the carbon black, for example, Asahi #15 or #15HS manufactured by ASAHI CARBON CO., LTD. can be used. Further, hybrid carbon in which carbon is attached to the surface of silica particles may be used.

### (Lubricant)

The magnetic layer 13 may include a lubricant. The lubricant may be one or two or more selected from a fatty acid and a fatty acid ester, and may include favorably both a fatty acid and a fatty acid ester. The above fatty acid may be favorably a compound represented by the following general formula (1) or (2). For example, one of the compound represented by the following general formula (1) and the compound represented by the general formula (2) may be contained as the above fatty acid, or both of them may be contained. Further, the above fatty acid ester may be favorably a compound represented by the following general formula (3) or (4). For example, one of the compound represented by the following general formula (3) and the compound represented by the general formula (4) may be contained as the above fatty acid ester, or both of them may be contained. When the lubricant includes one or both of the compound represented by the general formula (1) and the compound represented by the general formula (2) and/or one or both of the compound represented by the general formula (3) and the compound represented by the general formula (4), it is possible to prevent the magnetic head from being damaged and suppress a decrease in output.

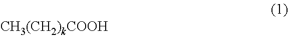

(However, in the general formula (1), k represents an integer selected from the range of 14 or more and 22 or less, more favorably the range of 14 or more and 18 or less.)

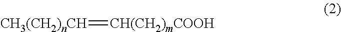

(However, in the above general formula (2), the sum of n and m is an integer selected from the range of 12 or more and 20 or less, more favorably the range of 14 or more and 18 or less.)

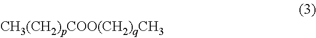

(However, in the general formula (3), p represents an integer selected from the range of 14 or more and 22 or less, more favorably the range of 14 or more and 18 or less, and q represents an integer selected from the range of 2 or more and 5 or less, more favorably the range of 2 or more and 4 or less.)

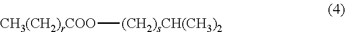

(However, in the above general formula (4), r represents an integer selected from the range of 14 or more and 22 or less, and s represents an integer selected from the range of 1 or more and 3 or less.)

Specific examples of the fatty acid and the fatty acid ester include the following. Examples of the fatty acid include capric acid, lauric acid, myristic acid, palmitic acid, stearic acid, oleic acid, elaidic acid, linoleic acid, and linolenic acid.

Further, examples of the fatty acid ester include butyl caprate, octyl caprylate, ethyl laurate, butyl laurate, octyl laurate, ethyl myristate, butyl myristate, octyl myristate, 2-ethylhexyl myristate, ethyl palmitate, butyl palmitate, octyl palmitate, 2-ethylhexyl palmitate, ethyl stearate, butyl stearate, isobutyl stearate, octyl stearate, 2-ethylhexyl stearate, amyl stearate, isoamyl stearate, 2-ethylpentyl stearate, 2-hexyldecyl stearate, isotridecyl stearate, amide stearate, alkylamide stearate, and butoxyethyl stearate.

### (Binder)

As the binder, a resin having as structure in which a cross-linking reaction is given to a polyurethane resin, a vinyl chloride resin, or the like is favorable. However, the binder is not limited thereto, and other resins may be appropriately blended depending on the physical properties required for the magnetic recording medium 10, and the like. The resin to be blended is not particularly limited as long as it is a resin commonly used in the coating type magnetic recording medium 10.

Examples of the binder include polyvinyl chloride, polyvinyl acetate, a vinyl chloride-vinyl acetate copolymer, a vinyl chloride-vinylidene chloride copolymer, a vinyl chloride-acrylonitrile copolymer, an acrylic acid ester-acrylonitrile copolymer, an acrylic acid ester-vinyl chloride-vinylidene chloride copolymer, an acrylic acid ester-vinylidene chloride copolymer, a methacrylic acid ester-vinylidene chloride copolymer, a methacrylic acid ester-vinyl chloride copolymer, a methacrylic acid ester-ethylene copolymer, polyvinyl fluoride, a vinylidene chloride-acrylonitrile copolymer, an acrylonitrile-butadiene copolymer, a polyamide resin, polyvinyl butyral, a cellulose derivative (cellulose acetate butyrate, cellulose diacetate, cellulose triacetate, cellulose propionate, nitrocellulose), a styrene butadiene copolymer, a polyester resin, an amino resin, and synthetic rubber.

Further, as the binder, a thermosetting resin or a reactive resin may be used. Examples thereof include a phenolic resin, an epoxy resin, a urea resin, a melamine resin, an alkyd resin, a silicone resin, a polyamine resin, and a urea formaldehyde resin.

In addition, a polar functional group such as —SO₃M, —OSO₃M, —COOM, and P═O(OM)₂ may be introduced into each of the above-mentioned binders for the purpose of improving dispersibility of the magnetic powder. Here, in the formula, M represents a hydrogen atom, or an alkali metal such as lithium, potassium, and sodium.

Further, examples of the polar functional groups include a side chain type having a terminal group represented by —NR1R2 or —NR1R2R3⁺X⁻, and a main chain type having >NR1R2⁺X⁻. Here, in the formula, R1, R2, and R3 each represent a hydrogen atom or a hydrocarbon group, and X⁻ represents a halogen element ion such as fluorine, chlorine, bromine, and iodine, or an inorganic or organic ion. Further, examples of the polar functional group include —OH, —SH, —CN, and an epoxy group.

### (Additive)

The magnetic layer 13 may further contain, as non-magnetic reinforcing particles, aluminum oxide (α, β, or γ alumina), chromium oxide, silicon oxide, diamond, garnet, emery, boron nitride, titanium carbide, silicon carbide, titanium carbide, titanium oxide (rutile or anatase type titanium oxide), or the like.

### (Coating Agent)

The magnetic layer 13 may include a coating agent in order to coat the surface of the magnetic powder. Examples of such a coating agent include organic acid having one or more polar groups such as carboxylic acid, phosphonic acid, and sulfonic acid, a metal salt thereof, which functions as an acid group, a coupling agent (silane, aluminum, titanium, and the like), carbon, a metal oxide, and a hydroxide (aluminum, yttrium, and the like). Examples of the organic acid include acetic acid, oxalic acid, citric acid, malonic acid, succinic acid, glutaric acid, adipic acid, phthalic acid, isophthalic acid, terephthalic acid, benzoic acid, toluic acid, p-hydroxybenzoic acid, naphthoic acid, naphthalenedicarboxylic acid, hydroquinone, phenylphosphonic acid, benzylphosphonic acid, phenethylphosphonic acid, diphenylmethylphosphonic acid, biphenylphosphonic acid, benzylphenylphosphonic acid, toluylphosphonic acid, hexylphosphonic acid, octylphosphonic acid, nonylphosphonic acid, decylphosphonic acid, undecylphosphonic acid, dodecylphosphonic acid, hexadecyl phosphonic acid, octadecylphosphonic acid, benzenesulfonic acid, p-toluenesulfonic acid, hexylbenzenesulfonic acid, octylbenzenesulfonic acid, decylbenzenesulfonic acid, undecylbenzenesulfonic acid, dodecylbenzenesulfonic acid, tridecylbenzenesulfonic acid, tetradecylbenzenesulfonic acid, hexadecyl benzenesulfonic acid, octadecylbenzenesulfonic acid, and naphthalenesulfonic acid.

### (Non-Magnetic Layer (Underlayer))

The non-magnetic layer (underlayer) 12 is a non-magnetic layer that includes a non-magnetic powder and a binder as the main components. The description regarding the binder included in the above-mentioned magnetic layer 13 also applies to the binder included in the non-magnetic layer 12. The non-magnetic layer 12 may further include, as necessary, at least one additive of a particle having conductivity, a lubricant, a curing agent, or a rust inhibitor.

The average thickness of the non-magnetic layer 12 may be favorably 1.3 μm or less, more favorably 1.2 μm or less, and still more favorably 1.0 μm or less. Further, the lower limit value of the average thickness of the non-magnetic layer 12 is not particularly limited, but is favorably 0.2 μm or more, more favorably 0.3 μm or more.

### (Non-Magnetic Powder)

The non-magnetic powder included in the non-magnetic layer 12 may include, for example, at least one selected from an inorganic particle and an organic particle. One type of non-magnetic powder may be used alone, or two or more types of non-magnetic powders may be used in combination. The inorganic particle includes, for example, one selected from a metal, a metal oxide, a metal carbonate, a metal sulfate, a metal nitride, a metal carbide, and a metal sulfide, or a combination of two or more of them. More specifically, the inorganic particle may be, for example, one or two or more selected from iron oxyhydroxide, hematite, titanium oxide, and carbon black. Examples of the shape of the non-magnetic powder include, but not particularly limited to, various shapes such as a needle shape, a spherical shape, a cubic shape, and a plate shape.

### (Coating Agent)

The non-magnetic layer 12 may include a coating agent in order to coat the surface of the non-magnetic powder. Such a coating agent may be the same as that included in the magnetic layer 13. Therefore, description of the coating agent will be omitted.

### (Back Layer)

The back layer 14 may include a binder and a non-magnetic powder. The back layer 14 may include, as necessary, various additives such as a lubricant, a curing agent, an antistatic agent, and organic acid. The description regarding the binder and the non-magnetic powder included in the above-mentioned non-magnetic layer 12 also applies to the binder and the non-magnetic powder included in the back layer 14.

The average particle size of the inorganic particles included in the back layer 14 is favorably 10 nm or more and 150 nm or less, more favorably 15 nm or more and 110 nm or less. The average particle size of the inorganic particles is obtained in the same manner as that for the average particle size D of the above magnetic powder.

An average thickness t_{b} of the back layer 14 may be favorably 0.6 μm or less, more favorably 0.5 μm or less, and still more favorably 0.4 μm or less, 0.3 μm or less, 0.25 μm or less, or 0.2 μm or less. When the average thickness t_{b} of the back layer 14 is within the above range, the average thicknesses of the non-magnetic layer 12 and the base layer 11 can be kept thick even in the case where the average thickness (average total thickness) t_{T} of the magnetic recording medium 10 satisfies the following relationship: t_{T}≤5.9 μm. This makes it possible to maintain travelling stability of the magnetic recording medium 10 in a recording/reproduction apparatus.

### (3) Physical Properties and Structure

### (Surface Roughness Rab)

The surface roughness Rab refers to a value measured on a surface 13S of the magnetic layer 13 of the magnetic recording medium 10. The surface roughness Rab is 1.70 nm or less, favorably 1.67 nm or less, more favorably 1.64 nm or less, and still more favorably 1.61 nm or less. Further, the lower limit value of the surface roughness Rab is not particularly limited, but is favorably 1.2 nm or more. When the surface roughness Rab is within the above range, it is possible to improve the electromagnetic conversion characteristics of the magnetic recording medium 10.

The surface roughness Rab is obtained as follows. First, a magnetic tape T housed in a cartridge 10A is unwound, and approximately 10 cm of the magnetic tape T is cut out at a position 30 m to 40 m in the longitudinal direction from the connection part between the magnetic tape T and a leader tape LT and attached to a slide glass (i.e., the back layer surface is attached to the slide glass) to obtain a sample piece. Next, the surface roughness of the surface 13S of the magnetic layer of the sample piece is measured by a non-contact profilometer using the following optical interference.
Apparatus: non-contact profilometer using optical interference
(non-contact surface/layer cross-sectional shape measurement system VertScan R5500GL-M100-AC manufactured by Ryoka Systems Inc.)
Objective lens: 20 times (approximately 236 μm×177 μm field of view)
Resolution: 640 points×480 points
Measurement mode: phase
Wavelength filter: 520 nm
Surface correction: correction using a 4th order polynomial approximation surface

The surface roughness is measured at at least five positions in the longitudinal direction as described above, and then, an average value of arithmetic average roughnesses Sa (nm) automatically calculated from the surface profile obtained at each position is used as the surface roughness Rab (nm).

### (Arithmetic Average Roughness Ra)

The arithmetic average roughness Ra refers to a value measured on the surface 13S of the magnetic layer 13 of the magnetic recording medium 10. The arithmetic average roughness Ra of the surface 13S is obtained as follows. First, the magnetic tape T housed in the cartridge 10A is unwound, and approximately 5 cm of the magnetic tape T is cut out at a position 30 m to 40 m in the longitudinal direction from the connection part between the magnetic tape T and the leader tape LT and attached to a slide glass (i.e., the back layer surface is attached to the slide glass) to obtain a sample piece. Next, the surface of the magnetic layer 13 is observed with an atomic force microscope (hereinafter, abbreviated as AFM) to obtain an AFM image of 40 μm×40 μm. Note that three AFM images are taken from one sample, and an average value of N=3 is used as the “arithmetic average roughness”. Nano Scope IIIa D3100 manufactured by Digital Instruments is used as the AFM, a cantilever formed of silicon single crystal is used, and measurement is performed with a tapping frequency tuned to 200 Hz to 400 Hz. As the cantilever, for example, “SPM probe NCH normal type PointProbe with L (cantilever length)=125 μm” manufactured by Nano World can be used.

Next, the AFM image is divided into 256×256 (=65536) measurement points, a height Z (i) (i: measurement point number, i=1 to 65536) is measured at each measurement point, and the measured heights Z(i) at the respective measurement points are simply averaged (arithmetically averaged) to obtain an average height (average surface) Zave (=(Z(1)+Z(2)+ . . . +Z(65536))/65536). Subsequently, a deviation Z″(i) (=|Z(i)−Zave|) from the average center line at each measurement point is obtained to calculate an arithmetic average roughness Ra [nm] (=(Z″(1)+Z″(2)+ . . . +Z″(65536))/65536). At this time, one that has been subjected to filtering by second-order Flatten and third-order planefit in XY as image processing is used as data.

### (PSD Value at Spatial Wavelength of 5 μm or Less)

Further, in the magnetic layer 13, the PSD (Power Spectrum Density) up to the spatial wavelength of 5 μm is 3.77 nm² or less, favorably 3.48 nm² or less, more favorably 3.15 nm² or less, and still more favorably 2.95 nm² or less. By setting the PSD to a predetermined value or less, it is possible to reduce the spacing between the recording/reproduction head and the tape during recording and reproduction and obtain a medium suitable for high recording density.

The PSD is measured as follows. First, the magnetic tape T housed in the cartridge 10A is unwound, and approximately 5 cm of the magnetic tape T is cut out at a position 30 m to 40 m in the longitudinal direction from the connection part between the magnetic tape T and the leader tape LT and attached to a slide glass (i.e., the back layer surface is attached to the slide glass) to obtain a sample piece. Next, the surface of the magnetic tape is observed with an atomic force microscope (AFM) to obtain two-dimensional (2D) surface profile data. The AFM suitable for measurement is shown below.
Apparatus: AFM Dimension 3100 microscope (NanoscopeIV including a controller) (Digital Instruments, USA)
Cantilever: NCH-10T (NanoWorld)

### <AFM Measurement Conditions>

Measurement area: 40 μm×40 μm
Resolution: 256×256
Probe scan direction of AFM: MD direction (longitudinal direction) of a magnetic tape
Measurement mode: tapping mode
Scan ratio: 1 Hz

Next, the following filter processing is performed on the 2D surface profile data obtained by the AFM.
Flatten: third-order
Planefit: third-order only in MD direction

Next, fast Fourier transform (FFT) is performed on each of 256 lines in the MD direction of the 2D surface profile data after the filter processing to obtain 256 power spectrum densities (PSDs). Next, the 256 obtained PSDs in the MD direction are averaged for each wavelength to obtain one averaged PSD in the MD direction (hereinafter, referred to a “PSDMD” or “PSD(k)MD”.). Note that the following formula (1) is used to average the PSDs in the MD direction.

$$[ Math . 1 ]$$

$${PSD ( k )}_{MD} = {( \frac{2 d}{N} {\vert {\sum }_{n = 0}^{N - 1} Z ( n ) \cdot {e}^{( \frac{2 π ikn}{N} )} \vert}^{2} )}_{average} \qquad ( 1 )$$

PSD: power spectrum density (nm³)
z(n): surface profile data at the nth point (nm)
d: resolution (nm)=L/N
L: measurement range (30 μm) in X-axis direction (or Y-axis direction)
N: number of points (256 points) in X-axis direction
i: imaginary unit
e: Napier number
Average: averaging operation in Y-axis direction (or X-axis direction)
n: variable (0 to N−1)
k: wavenumber (0 to N−1)

Note that the X-axis direction corresponds to the MD direction (longitudinal direction).

Of the PSD values at the respective wavelengths obtained up to this point, the PSD values at the wavelength of 5 μm or less are accumulated and used.

### (Average Height of Protrusion Formed by Alumina Particles)

The magnetic recording medium has an average height of a protrusion formed by the alumina particle of 0.0067 μm or less, favorably 0.0060 μm or less, more favorably 0.0057 μm or less, and still more favorably 0.0050 μm or less.

The height of the protrusion formed by alumina particles is measured by performing shape analysis on the same position of the measurement sample using an atomic force microscope (hereinafter, referred to as an AFM) and identifying the component on which image analysis has been performed using a difference in luminance caused by the difference in the amount of secondary electrons emitted by the alumina particle and the particle having conductivity from an FE-SEM image taken by a field emission scanning electron microscope (hereinafter, referred to as an FE-SEM), as will be described below. The height of the protrusion can be measured by the AFM, and whether each protrusion is formed by the alumina particles or the particle having conductivity can be determined by the FE-SEM. The image obtained by the AFM for the same position and the image obtained by the FE-SEM for the certain region are overlayed to obtain a composite image, and the type of particle forming each protrusion (whether it is the alumina particle or the particle having conductivity) and the height of each protrusion can be associated with each other from the obtained composite image.

A method of measuring the height of the protrusion using the AFM, a method of identifying the type of particle forming the protrusion using the FE-SEM, and a method of associating the height of the protrusion and the type of particle forming the protrusion with each other will be described below.

### (Method of Measuring Height of Protrusion Using Atomic Force Microscope (AFM))

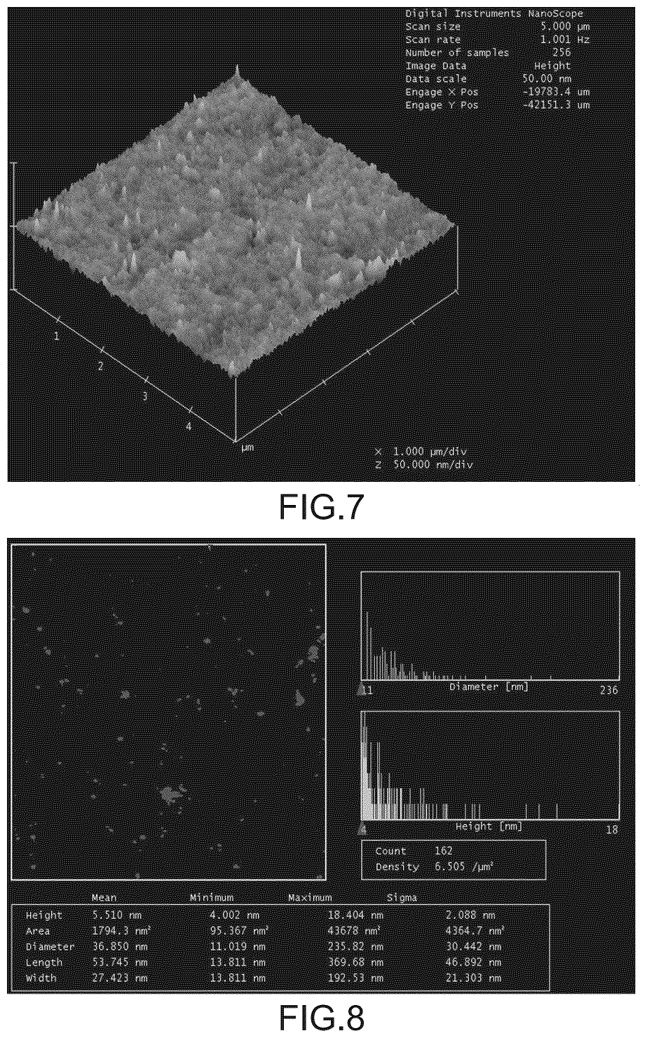

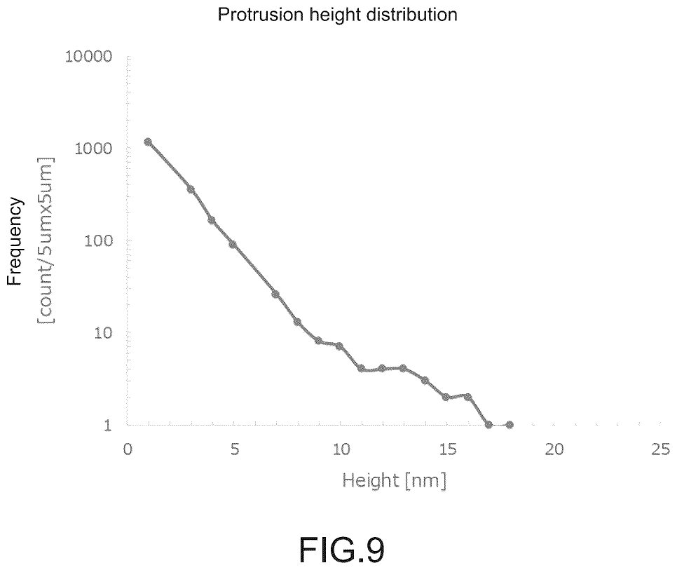

In the present technology, the height of the protrusion formed by the alumina particles is obtained as follows. First, the user data area (24 m or more from the leader pin) of the magnetic recording medium 10 in the LTO cartridge is cut into a size that can be placed on a sample stage for SEM observation to prepare a measurement sample. Next, marking is performed on the surface of the measurement sample avoiding the center of the measurement sample. Examples of the marking method include a method of forming linear or dot-shaped recesses on the magnetic recording medium 10 using a manipulator or a nanoindenter, and a method of forming a projecting portion on the magnetic recording medium 10 using silver paste or the like. Note that since the marked portion is scanned with a probe in the AFM, the tip of the probe becomes dirty depending on the state of the marked portion and an accurate shape image cannot be obtained in some cases. Thus, it is favorable to make the marking small and shallow such that the probe is not contaminated. Next, the marked portion on the surface of the measurement sample is subjected to shape analysis by the AFM. Since the marked portion is recessed, measurement is performed with the viewing angle of 5 μm×5 μm by the AFM such that the marked portion is as close to the edge of the field of view as possible. Note that the protrusions around the marked portion are not measured. Next, measurement is performed with the viewing angle of 10 μm×10 μm, a portion to be used as a mark is determined, and a non-marking portion is measured with the viewing angle of 5 μm×5 μm in accordance with the portion to be used as a mark. The measurement conditions for the shape analysis are as described below. For alumina particles, in the case where 20 or more particles can be identified in one AFM field of view from one measurement sample, one field of view is measured by the AFM. For alumina particles, in the case where the number of particles that can be identified in one AFM field of view is less than 20, a plurality of (e.g., 3 to 5) field of views is measured from one measurement sample. For alumina particles, 20 points identified as particles by binarization processing are secured, the 20 measure values by the AFM are averaged, and the obtained average value is used as the height of the protrusion. Information regarding a surface shape, protrusion analysis, and a protrusion height distribution can be obtained by the shape analysis. FIG. 7 is an example of an image showing an example of a surface shape taken by the AFM. FIG. 8 is a diagram showing an example of a protrusion analysis result by the AFM. FIG. 9 is a diagram showing an example of a protrusion height distribution. Data regarding the number of formed protrusions, the height of the protrusion formed by the particles, and the like can be obtained from the obtained information.

### <AFM Measurement Conditions>

Apparatus: AFM Dimension 3100 microscope (NanoscopeIV including a controller) (Digital Instruments, USA)
A measurement mode: tapping
Tapping frequency during tuning: 200 to 400 KHz
Cantilever: SNL-10 (manufactured by Bruker)
Scan size: 5 μm×5 μm
Scan rate: 1 Hz
Scan line: 256
   <Method of Calculating Reference Surface when Calculating Protrusion Height>

The AFM image is divided into 256×256 (=65,536) measurement points, a height Z(i) (i: measurement point number, i=1 to 65,536) is measured at each measurement point, and the measured heights Z(i) at the respective measurement points are simply averaged (arithmetically averaged) to obtain an average height (average surface) Zₐᵥₑ (=(Z(1)+Z(2)+ . . . +Z(65536))/65536).

### (Method of Identifying Type of Particle Forming Protrusion Using FE-SEM)

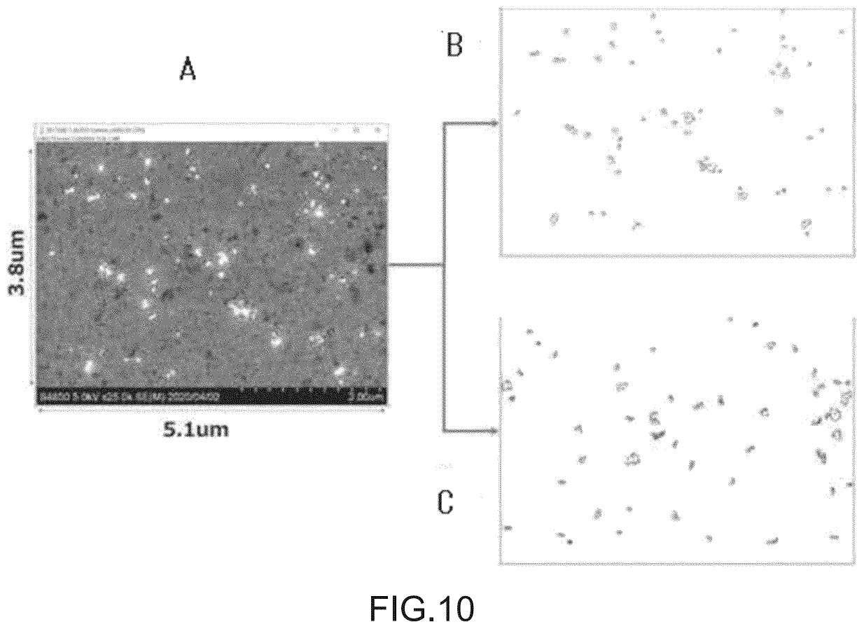

The marked portion of the measurement sample is imaged using a field emission scanning electron microscope (FE-SEM) under the FE-SEM measurement conditions described below to obtain an FE-SEM image. Part A of FIG. 10 shows an example of an FE-SEM image. The type of particle forming the protrusion can be identified using a difference in luminance caused by the difference in the amount of secondary electrons emitted by the alumina particle and the particle having conductivity from the obtained FE-SEM image. The image processing for the identification will be described below. Further, the positions of the protrusions formed by the alumina particle and the particle having conductivity in the FE-SEM image are identified.

### <FE-SEM Measurement Conditions>

Apparatus: HITACHI S-4800 (manufactured by Hitachi High-Technologies Corporation)
Viewing angle: 5.1 μm×3.8 μm
Acceleration voltage: 5 kV
Measurement magnification: 25000 times

The obtained FE-SEM image (Part A of FIG. 10) is binarized using image processing software Image J under each of the two processing conditions described below. Information regarding the number of protrusions formed by each of the alumina particle and the particle having conductivity, the average area per protrusion, the total area of the protrusions, and the diameter (Feret diameter) of the protrusion is obtained from the image obtained by the binarization processing. Note that when performing the binarization processing, the conditions are changed as follows between the alumina particle having high luminance (white portions in Part A of FIG. 10) and the particle having conductivity and low luminance (black portions in Part A of FIG. 10).

### <Binarization Processing Conditions for Obtaining Information Regarding Alumina Particle>

Software: Image J Ver 1.44p
Binarization threshold value: Threshold (220, 255) Binarization target size: 0.001 μm-infinity

### <Binarization Processing Conditions for Obtaining Information Regarding Particle Having Conductivity>

Software: Image J Ver 1.44p
Binarization threshold value: Threshold (0.65)
Binarization target size: 0.002 μm-infinity

Part B of FIG. 10 is an image obtained by binarizing the FE-SEM image of Part A of FIG. 10 under the binarization processing conditions for alumina particles to show the position distribution of protrusions formed by alumina particles. The following information regarding an alumina particle was obtained from the obtained image.

### <Obtained Information Regarding Alumina Particle>

Number: 58
Average area: 0.003 μm²
Total area: 0.198 μm²
Feret diameter: 0.091 μm

Part C of FIG. 10 is an image obtained by binarizing the FE-SEM image of Part A of FIG. 10 under the binarization processing conditions for particles having conductivity (carbon black particles) to show the position distribution of protrusions formed by the particles having conductivity (carbon black particles). The following information regarding a particle having conductivity was obtained from the obtained image.

### <Obtained Information Regarding Particle Having Conductivity>

Number: 55
Average area: 0.005 μm²
Total area: 0.262 μm²
Feret diameter: 0.013 μm
   (Method of Associating Height of Protrusion and Type of Particle Forming Protrusion with Each Other)

The obtained AFM image and the FE-SEM image before the binarization processing are overlaid to obtain a composite image. Whether the particle forming each protrusion is an alumina particle or a particle having conductivity is determined using the synthesized image.

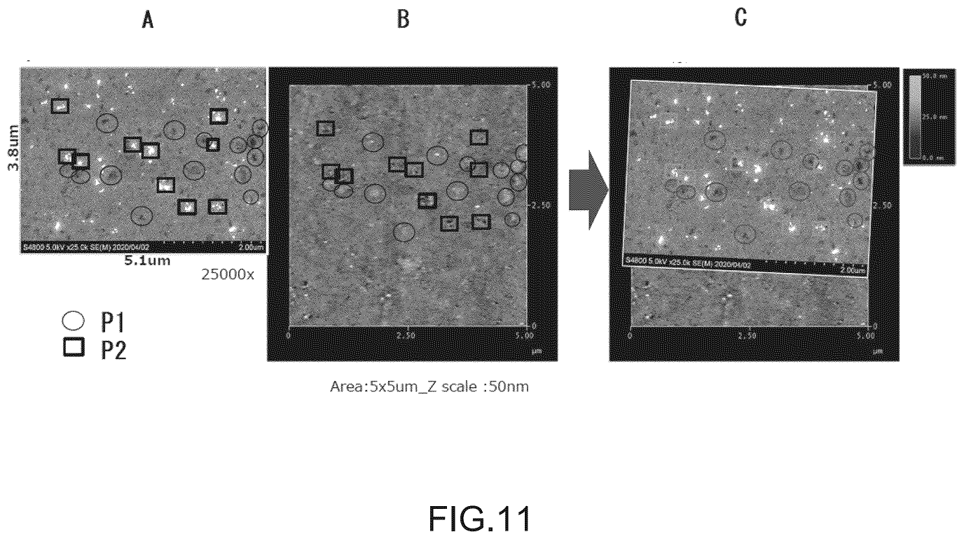

For example, Part C of FIG. 11 is a composite image the AFM image (Part B) and the FE-SEM image (Part A) are overlaid such that the positions of the corresponding protrusions match. In FIG. 11, different marks are applied to the position of the protrusion formed by a particle P1 having conductivity, which is present in the FE-SEM image before the image synthesis (Part A) and identified by the binarization processing, and the position of the protrusion formed by an alumina particle P2 such that these positions can be distinguished from each other. Similarly, different marks are applied to the position of the protrusion formed by the particle P1 having conductivity, which is present in the AFM image before the image synthesis (Part B) and identified by the binarization processing, and the position of the protrusion formed by the alumina particle P2 such that these positions can be distinguished from each other. From the composite image obtained by overlaying the AFM image (Part B) and the FE-SEM image (Part A) such that the positions of the corresponding protrusions match, whether each protrusion is formed by the particle P1 having conductivity or the alumina particle P2 is determined. Note that in FIG. 11 (Part B), since the marked portion is measured with the viewing angle of 10 μm×10 μm by the AFM and then the non-marking portion is measured with the viewing angle of 5 μm×5 μm, no marking is present in the image.

Next, the height of each protrusion in the composite image is measured using AFM analysis software (Software version 5.12 Rev.B for Dimension 3100 manufactured by Veeco Instruments Inc.). Since the type of particle forming each protrusion (whether it is an alumina particle or a particle having conductivity) is identified as described above, the identified type of particle is associated with the measured height.

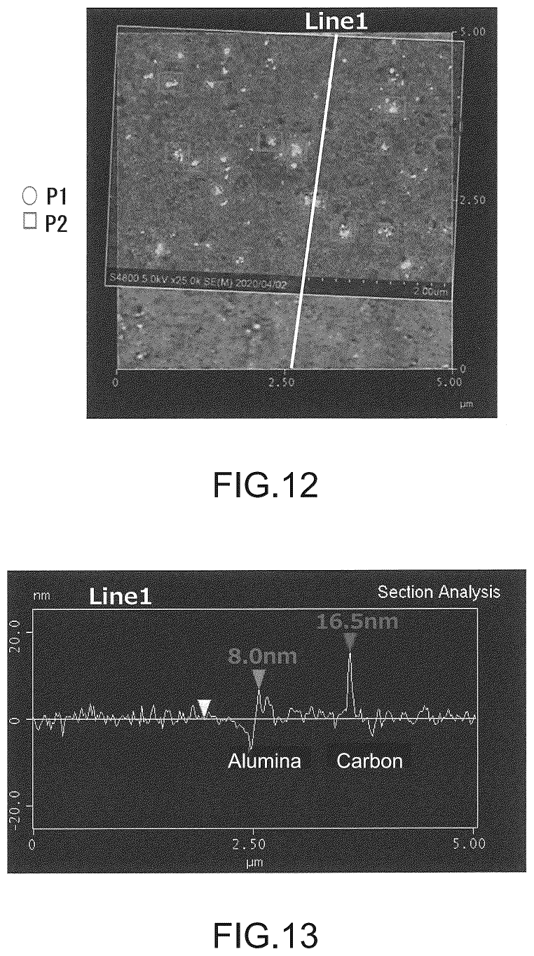

For example, FIG. 12 is an enlarged view of the composite image obtained by overlaying the AFM image and the FE-SEM image. FIG. 13 is a diagram showing an analysis result (measurement result of the protrusion height) by the AFM for the line 1 (Line1) set at an arbitrary position in FIG. 12. As shown in FIG. 13, the height of the protrusion formed by the alumina particle present on the line 1 can be determined. In this way, the height of the protrusion is determined from the composite image and the AFM analysis result.

### (Average Height of Protrusion)

The average height of the protrusions formed by alumina particles is obtained from the information regarding the height of a protrusion obtained as described above. The average height of the protrusion can be obtained from, for example, a cumulative frequency distribution of the protrusions formed by alumina particles.

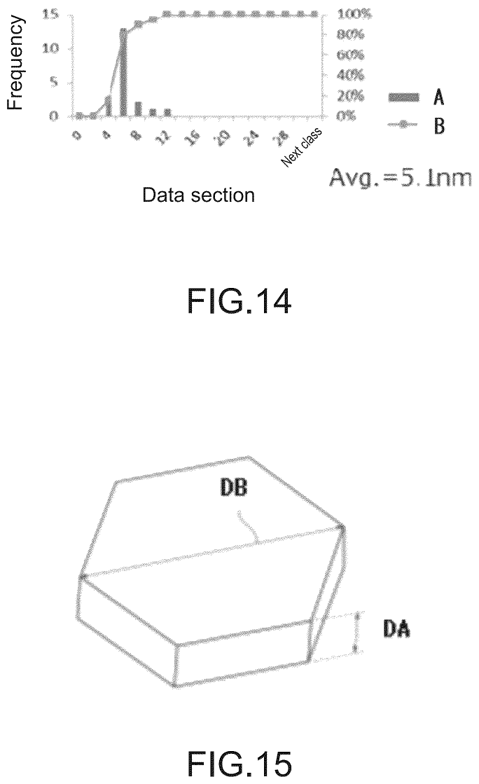

Further, for example, FIG. 14 is a diagram showing a cumulative frequency distribution of the heights of the protrusions formed by alumina particles. In FIG. 14, A indicates the frequency and B indicates the cumulative percentage. FIG. 14 shows that the average height of the protrusions formed by alumina particles is 5.1 nm.

### (Electromagnetic Conversion Characteristics (SNR) of Magnetic Recording Medium (Magnetic Tape))

First, a reproduction signal of the magnetic tape was acquired using a loop tester (manufactured by Microphysics). The conditions for acquiring the reproduction signal are shown below.
Head: GMR
Headspeed: 1.85 m/s
Signal: single recording frequency of 10 MHz (as a 2T half Nyquist frequency)
Recording current: optimal recording current

Next, the reproduction signal was captured by a spectrum analyzer with a span of 0 to 20 MHz (resolution band width=100 kHz, VBW=30 kHz). Next, the peak of the captured spectrum was taken as a signal amount S, the floor noise excluding the peak was integrated to obtain a noise amount N, and a ratio S/N of the signal amount S and the noise amount N was obtained as an SNR (Signal-to-Noise Ratio). Next, the obtained SNR was converted into a relative value (dB) with reference to the SNR in Comparative Example 1 as a reference medium.

### (Average Thickness (Average Total Thickness) t_{T} of Magnetic Recording Medium (Magnetic Tape))

The average thickness tr of the magnetic tape T is obtained as follows. First, the magnetic tape T housed in the cartridge 10A is unwound, and the magnetic tape T is cut into a length of 250 mm at a position 30 m in the longitudinal direction from the connection port between the magnetic tape T and the leader tape LT to prepare a sample. Next, a Laser Hologage (LGH-110C) manufactured by Mitutoyo Corporation is used as a measuring apparatus to measure the thickness of the sample at five positions, and the measured values are simply averaged (arithmetically averaged) to calculate an average thickness t_{T} [μm]. Note that the above five measurement positions are randomly selected from the sample such that they are different positions in the longitudinal direction of the magnetic tape T.

### (Average Thickness of Non-Magnetic Layer (Underlayer))

The average thickness of the non-magnetic layer 12 is obtained as follows. First, the magnetic tape T housed in the cartridge 10A is unwound, and the magnetic tape T is cut into a length of 250 mm at positions 10 m, 30 m, and 50 m in the longitudinal direction from the connection part between the magnetic tape T and the leader tape LT to prepare three samples. Subsequently, each sample is processed by the FIB method or the like to obtain a slice. In the case of using the FIB method, a carbon layer and a tungsten layer are formed as protective films as pre-processing for observing a TEM image of a cross section described below. The carbon layer is formed on the surface on the side of the magnetic layer 13 and the surface on the side of the back layer 14 of the magnetic tape T by a vapor deposition method, and the tungsten layer is further formed on the surface on the side of the magnetic layer 13 by a vapor deposition method or a sputtering method. The slicing is performed along the longitudinal direction of the magnetic tape T. That is, the slicing forms a cross section parallel to both the longitudinal direction and the thickness direction of the magnetic tape T.

The above cross section of each obtained sliced sample is observed using a transmission electron microscope (TEM) under the following conditions.
Apparatus: TEM (H9000NAR manufactured by Hitachi, Ltd.)
Acceleration voltage: 300 kV
Magnification: 100,000 times

Next, the thickness of the non-magnetic layer 12 is measured at at least 10 positions in the longitudinal direction of the magnetic tape T using the obtained TEM image, and then, the measured values are simply averaged (arithmetically averaged) to obtain the average thickness (μm) of the non-magnetic layer 12.

### (Average Thickness of Base Layer)

The average thickness of the base layer 11 is obtained as follows. First, the magnetic tape T housed in the magnetic recording cartridge 10A is unwound, and the magnetic tape T is cut into a length of 250 mm at a position 30 m in the longitudinal direction from the connection port between the magnetic tape T and the leader tape LT to prepare a sample. In the present specification, the “longitudinal direction” in the “longitudinal direction from the connection part between the magnetic tape T and the leader tape LT” means a direction from one end on the side of the leader tape LT to the other side on the side opposite thereto.

Subsequently, the layers other than the base layer 11 of the sample (i.e., the non-magnetic layer (underlayer) 12, the magnetic layer 13, and the back layer 14) are removed using a solvent such as MEK (methyl ethyl ketone) and dilute hydrochloric acid. Next, a Laser Hologage (LGH-110C) manufactured by Mitutoyo Corporation is used as a measuring apparatus to measure the thickness of the sample (base layer 11) at five positions, and the measured values are simply averaged (arithmetically averaged) to calculate the average thickness of the base layer 11. Note that the above five measurement positions are randomly selected from the sample such that they are different positions in the longitudinal direction of the magnetic tape T.

### (Average Thickness t_{b} of Back Layer)

The average thickness t_{b} of the back layer 14 is obtained as follows. First, the average thickness (average total thickness) tr of the magnetic tape T is measured. The method of measuring the average thickness t_{T} (average total thickness) is as described in the following “Average thickness of magnetic tape”. Subsequently, the magnetic tape T housed in the cartridge 10A is unwound, and the magnetic tape T is cut into a length of 250 mm at a position 30 m in the longitudinal direction from the connection port between the magnetic tape T and the leader tape LT to prepare a sample. Next, the back layer 14 of the sample is removed with a solvent such as MEK (methyl ethyl ketone) and dilute hydrochloric acid. Next, a Laser Hologage (LGH-110C) manufactured by Mitutoyo Corporation is used to measure the thickness of the sample at five positions, and the measured values are simply averaged (arithmetically averaged) to calculate an average value t_{B} [μm]. After that, the average thickness t_{b} [μm] of the back layer 14 is obtained from the following formula. Note that the above five measurement positions are randomly selected from the sample such that they are different positions in the longitudinal direction of the magnetic tape T.

t_{b} [μm]=t_{T} [μm]−t_{B} [μm]

### (Average Thickness tₘ of Magnetic Layer)

The average thickness tₘ of the magnetic layer 13 is obtained as follows. First, the magnetic tape T housed in the cartridge 10A is unwound, and the magnetic tape T is cut into a length of 250 mm at positions 10 m, 30 m, and 50 m in the longitudinal direction from the connection part between the magnetic tape T and the leader tape LT to prepare three samples. Subsequently, each sample is processed by the FIB method or the like to obtain a slice. In the case of using the FIB method, a carbon layer and a tungsten layer are formed as protective films as pre-processing for observing a TEM image of a cross section described below. The carbon layer is formed on the surface on the side of the magnetic layer 13 and the surface on the side of the back layer 14 of the magnetic tape T by a vapor deposition method, and the tungsten layer is further formed on the surface on the side of the magnetic layer 13 by a vapor deposition method or a sputtering method. The slicing is performed along the longitudinal direction of the magnetic tape T. That is, the slicing forms a cross section parallel to both the longitudinal direction and the thickness direction of the magnetic tape T.

The above cross section of each obtained sliced sample is observed using a transmission electron microscope (TEM) under the following conditions to obtain a TEM image of each sliced sample. Note that the magnification and the acceleration voltage may be adjusted as appropriately in accordance with the type of apparatus.
Apparatus: TEM (H9000NAR manufactured by Hitachi, Ltd.)
Acceleration voltage: 300 kV
Magnification: 100,000 times

Next, the thickness of the magnetic layer 13 is measured at 10 positions of each sliced sample using the TEM image of each obtained sliced sample. Note that the 10 measurement positions of each sliced sample are randomly selected from the sample such that they are different positions in the longitudinal direction of the magnetic tape T. An average value obtained by simply averaging (arithmetically averaging) the measured values (total of 30 thicknesses of the magnetic layer 13) of each obtained sliced sample is used as the average thickness tₘ [nm] of the magnetic layer 13.

### (Average Particle Size of Magnetic Powder)

In the case where the magnetic powder includes a powder of the hexagonal ferrite particles, the average particle size and the average aspect ratio of the magnetic powder are obtained as follows. First, the magnetic tape T housed in the cartridge 10A is unwound, and the magnetic tape T is cut out at a position 30 m in the longitudinal direction from the connection port between the magnetic tape T and the leader tape LT. Subsequently, the magnetic tape T to be measured is processed by the FIB method or the like to obtain a slice. In the case of using the FIB method, a carbon layer and a tungsten layer are formed as protective films as pre-processing for observing a TEM image of a cross section described below. The carbon layer is formed on the surface on the side of the magnetic layer 13 and the surface on the side of the back layer 14 of the magnetic tape T by a vapor deposition method, and the tungsten layer is further formed on the surface on the side of the magnetic layer 13 by a vapor deposition method or a sputtering method. The slicing is performed along the length direction (longitudinal direction) of the magnetic tape T. That is, the slicing forms a cross section parallel to both the longitudinal direction and the thickness direction of the magnetic tape T.

The above cross section of the obtained sliced sample is observed using a transmission electron microscope (H-9500 manufactured by Hitachi High-Technologies Corporation) at an acceleration voltage: 200 kV and a total magnification of 500,000 times such that the entire magnetic layer 13 is included in the thickness direction of the magnetic layer 13 to take a TEM photograph. TEM photographs are prepared in such a number that 50 particles for which a plate diameter DB and a plate thickness DA (see FIG. 15) shown below can be measured can be extracted.

In the present specification, regarding the size of hexagonal ferrite particles (hereinafter, referred to as a “particle size”.), in the case where the shape of the particle observed in the above TEM photograph is a plate shape or a columnar shape (however, the thickness or height is smaller than the long diameter of the plate surface or bottom surface.) as shown in FIG. 15, the long diameter of the plate surface or bottom surface thereof is used as the value of the plate diameter DB. The thickness or height of the particle observed in the above TEM photograph is used as the value of the plate thickness DA. In the case where the plate surface or bottom surface of the particle observed in the TEM photograph has a hexagonal shape, the long diameter means the longest diagonal distance. In the case where the thickness or height of the particle is not constant in one particle, the maximum thickness or height of the particle is used as the plate thickness DA.

Next, 50 particles to be extracted from the taken TEM photograph are selected on the basis of the following criteria. Particles partially protruding outside the field of view of the TEM photograph are not measured, and particles with clear contours and present in isolation are measured. In the case where particles overlap with each other, each particle is measured as a single particle if the boundary between them is clear and the shape of the entire particle can be determined. However, particles whose boundaries are unclear and whose overall shape cannot be determined are not measured because the shape of the particle cannot be determined.

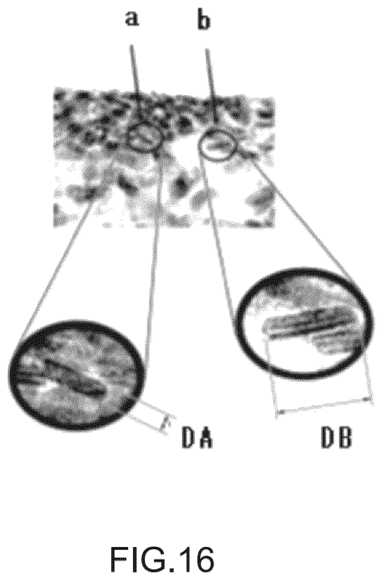

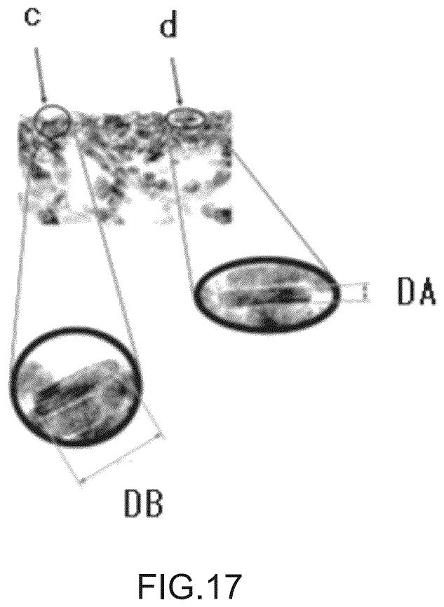

FIG. 16 and FIG. 17 each show an example of the TEM photograph. In FIG. 16 and FIG. 17, for example, particles indicated by arrows a and d are selected because their plate thickness (thickness or height of the particle) DA can be clearly checked. The plate thickness DA of each of the 50 selected particles is measured. The plate thicknesses DA obtained in this way are simply averaged (arithmetically averaged) to obtain an average plate thickness DAₐᵥₑ. The average plate thickness DAₐᵥₑ is the average particle plate thickness. Subsequently, the plate diameter DB of each of the magnetic powders is measured. In order to measure the plate diameter DB of the particle, 50 particles whose plate diameter DB can be clearly observed are selected from the taken TEM photograph. For example, in FIG. 16 and FIG. 17, particles indicated by arrows b and c are selected because their plate diameter DB can be clearly checked. The plate diameter DB of each of the selected 50 particles is measured. The plate diameters DB obtained in this way are simply averaged (arithmetically averaged) to obtain an average plate diameter DBₐᵥₑ. The average plate diameter DBₐᵥₑ is the average particle size. Then, the average aspect ratio (DBₐᵥₑ/DAₐᵥₑ) of the particles is obtained on the basis of the average plate thickness DAₐᵥₑ and the average plate diameter DBₐᵥₑ.

### (Average Particle Volume of Magnetic Powder)

The average particle volume of the magnetic powder is obtained as follows. First, the average plate thickness DAₐᵥₑ and the average plate diameter DBₐᵥₑ are obtained as described regarding the above method of calculating the average particle size of the magnetic powder. Next, the average particle volume V of the magnetic powder is obtained by the following formula.

$$[ Math . 2 ]$$

$$V = \frac{3 \sqrt{3}}{8} \times {DA}_{ave} \times {DB}_{ave} \times {DB}_{ave}$$

### (4) Method of Producing Magnetic Recording Medium

Next, a method of producing of the magnetic recording medium 10 having the above-mentioned configuration will be described. First, a non-magnetic powder, a binder, and the like are kneaded and/or dispersed in a solvent to prepare a paint for forming a non-magnetic layer (underlayer). Next, a magnetic powder, a binder, and the like are kneaded and/or dispersed in a solvent to prepare a paint for forming a magnetic layer. For example, the following solvents, dispersing apparatuses, and kneading apparatuses can be used to prepare the paint for forming a magnetic layer and the paint for forming a non-magnetic layer (underlayer).

Examples of the solvent to be used for preparing the above-mentioned paints include a ketone solvent such as acetone, methyl ethyl ketone, methylisobutylketone, and cyclohexanone; an alcohol solvent such as methanol, ethanol, and propanol; an ester solvent such as methyl acetate, ethyl acetate, butyl acetate, propyl acetate, ethyl lactate, and ethylene glycol acetate; an ether solvent such as diethylene glycol dimethyl ether, 2-ethoxyethanol, tetrahydrofuran, and dioxane; an aromatic hydrocarbon solvent such as benzene, toluene, and xylene; and a halogenated hydrocarbon solvent such as methylene chloride, ethylene chloride, carbon tetrachloride, chloroform, and chlorobenzene. One of these may be used or a mixture of two or more of them may be used.

As the kneading apparatus to be used for preparing the above-mentioned paint, for example, a kneading apparatus such as a continuous twin-screw kneader, a continuous twin-screw kneader capable of performing dilution in multiple stages, a kneader, a pressure kneader, and a roll kneader can be used, but it does not necessarily need to use these apparatuses. Further, as the dispersion apparatus to be used for preparing the above-mentioned paints, for example, a dispersion apparatus such as a roll mill, a ball mill, a horizontal sand mill, a perpendicular sand mill, a spike mill, a pin mill, a tower mill, a pearl mill (e.g., a “DCP mill” manufactured by Eirich Co., Ltd.), a homogenizer, and an ultrasonic disperser can be used, but it does not necessarily need to use these apparatuses.

Next, the paint for forming a non-magnetic layer (underlayer) is applied onto one main surface of the base layer 11 and dried to form the non-magnetic layer 12. Subsequently, the paint for forming a magnetic layer is applied onto the non-magnetic layer 12 and dried to form the magnetic layer 13 on the non-magnetic layer 12. Note that during drying, for example, the magnetic field of the magnetic powder is oriented by a solenoid coil in the thickness direction of the base layer 11. Further, during drying, for example, the magnetic field of the magnetic powder may be oriented by a solenoid coil in the longitudinal direction (travelling direction) of the base layer 11 and then oriented in the thickness direction of the base layer 11. By performing such magnetic field orientation processing, it is possible to reduce a ratio Hc2/Hc1 of a coercive force “Hc2” in the longitudinal direction to a coercive force “Hc1” in the perpendicular direction, and improve the degree of perpendicular orientation of the magnetic powder. After forming the magnetic layer 13, the back layer 14 is formed on the other main surface of the base layer 11. In this way, the magnetic recording medium 10 is obtained.

The ratio Hc2/Hc1 is set to a desired value by adjusting, for example, the strength of the magnetic field to be applied to the coating film of the paint for forming a magnetic layer, the concentration of solids in the paint for forming a magnetic layer, or the drying conditions (drying temperature and drying time) of the coating film of the paint for forming a magnetic layer. The strength of the magnetic field to be applied to the coating film is favorably two times or more and three times or less the coercive force of the magnetic powder. In order to further increase the ratio Hc2/Hc1, it is also favorable to magnetize the magnetic powder before the paint for forming a magnetic layer enters an orientation apparatus for orienting the magnetic field of the magnetic powder. Note that the methods of adjusting the ratio Hc2/Hc1 may be used alone, or two or more of them may be used in combination.

After that, the obtained magnetic recording medium 10 is wound around the large-diameter core, and the curing processing is performed thereon. Finally, the magnetic recording medium 10 is calendared and then cut into a predetermined width (e.g., ½ inch width). In this way, a desired long elongated magnetic recording medium 10 can be obtained.

### (5) Recording/Reproduction Apparatus

### [Configuration of Recording/Reproduction Apparatus]

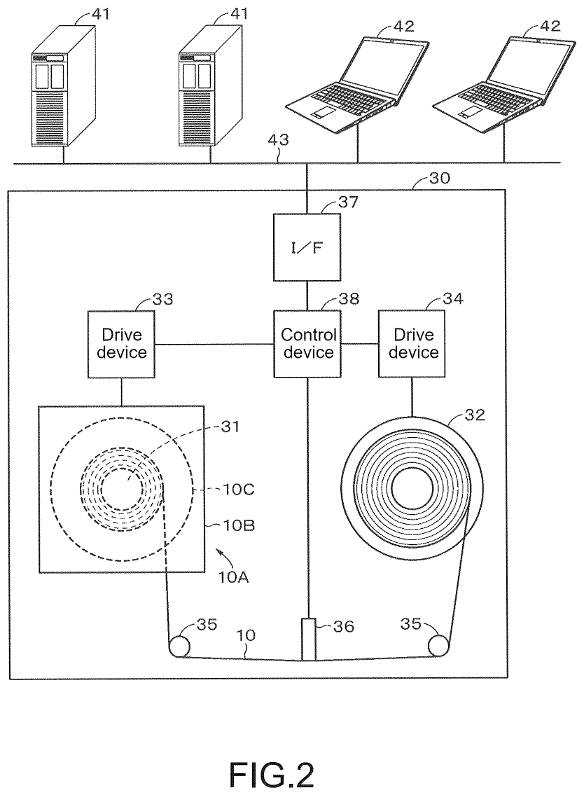

Next, an example of a configuration of a recording/reproduction apparatus 30 that performs recording and reproduction on the magnetic recording medium 10 having the above-mentioned configuration will be described with reference to FIG. 2.

The recording/reproduction apparatus 30 has a configuration capable of adjusting the tension applied in the longitudinal direction of the magnetic recording medium 10. Further, the recording/reproduction apparatus 30 has a configuration in which the magnetic recording cartridge 10A can be loaded. Here, for ease of description, a case where the recording/reproduction apparatus 30 has a configuration in which a single magnetic recording cartridge 10A can be loaded will be described. However, the recording/reproduction apparatus 30 may have a configuration in which a plurality of magnetic recording cartridges 10A can be loaded.

The recording/reproduction apparatus 30 is favorably a timing servo type magnetic recording/reproduction apparatus. The magnetic recording medium according to the present technology is suitable for use in the timing servo type magnetic recording/reproduction apparatus.

The recording/reproduction apparatus 30 is connected to an information processing apparatus such as a server 41 and a personal computer (hereinafter, referred to as “PC”.) 42 via a network 43, and is configured to be capable of recording data supplied from these information processing apparatuses on the magnetic recording cartridge 10A. The shortest recording wavelength of the recording/reproduction apparatus 30 is favorably 100 nm or less, more favorably 75 nm or less, still more favorably 60 nm or less, and particularly favorably 50 nm or less.

As shown in FIG. 2, the recording/reproduction apparatus includes a spindle 31, a reel 32 on the side of the recording/reproduction apparatus, a spindle drive device 33, a reel drive device 34, a plurality of guide rollers 35, a head unit 36, a communication interface (hereinafter, I/F) 37, and a control device 38.

The spindle 31 is configured to be capable of loading the magnetic recording cartridge 10A. The magnetic recording cartridge 10A conforms to the LTO (Linear Tape Open) standard, and rotatably houses, in a cartridge case 10B, a single reel 10C on which the magnetic recording medium 10 is wound. A servo pattern of the inverted V shape is recorded on the magnetic recording medium 10 in advance as a servo signal. The reel 32 is configured to be capable of fixing the tip of the magnetic recording medium 10 pulled out from the magnetic recording cartridge 10A.

The present technology also provides a magnetic recording cartridge that includes the magnetic recording medium according to the present technology. In the magnetic recording cartridge, the magnetic recording medium may be wound around, for example, a reel.

The spindle drive device 33 is a device that causes the spindle 31 to be driven to rotate. The reel drive device 34 is a device that causes the reel 32 to be driven to rotate. When recording or reproducing data on/from the magnetic recording medium 10, the spindle drive device 33 and the reel drive device 34 cause the spindle 31 and the reel 32 to be driven to rotate to cause the magnetic recording medium 10 to travel. The guide roller 35 is a roller for guiding the travelling of the magnetic recording medium 10.

The head unit 36 includes a plurality of recording heads for recording a data signal on the magnetic recording medium 10, a plurality of reproduction heads for reproducing the data signal recorded on the magnetic recording medium 10, and a plurality of servo heads for reproducing the servo signal recorded on the magnetic recording medium 10. As the recording head, for example, a ring-type head can be used, but the type of recording head is not limited thereto.

The communication I/F 37 is for communicating with an information processing apparatus such as the server 41 and the PC 42 and is connected to the network 43.

The control device 38 controls the entire recording/reproduction apparatus 30. For example, the control device 38 records the data signal supplied from the information processing apparatus on the magnetic recording medium 10 by the head unit 36 in accordance with a request from the information processing apparatus such as the server 41 and the PC 42. Further, the control device 38 reproduces the data signal recorded on the magnetic recording medium 10 and supplies the reproduced data signal to the information processing apparatus by the head unit 36 in accordance with a request from the information processing apparatus such as the server 41 and the PC 42.

Further, the control device 38 detects a change in the width of the magnetic recording medium 10 on the basis of the servo signal supplied from the head unit 36. Specifically, a plurality of servo patterns each having the inverted V shape is recorded on the magnetic recording medium 10 as servo signals, and the head unit 36 is capable of simultaneously reproducing two different servo patterns and obtaining respective servo signals by the two servo heads on the head unit 36. The relative position information between the servo pattern and the head unit obtained from this servo signal is used to control the position of the head unit 36 so as to follow the servo pattern. At the same time, it is also possible to obtain distance information between servo patterns by comparing the two servo signal waveforms. By comparing the distance information between servo patterns obtained at each measurement time, it is possible to obtain a change in the distance between servo patterns at each measurement time. By adding the distance information between servo patterns during servo pattern recording thereto, it is also possible to calculate a change in the width of the magnetic recording medium 10. On the basis of the change in the distance between servo patterns obtained as described above or the calculated change in the width of the magnetic recording medium 10, the control device 38 controls the driving rotation of the spindle drive device 33 and the reel drive device 34, and adjusts the tension of the magnetic recording medium 10 in the longitudinal direction such that the width of the magnetic recording medium 10 becomes a specified width or a substantially specified width. As a result, it is possible to suppress the change in the width of the magnetic recording medium 10.

### [Operation of Recording/Reproduction Apparatus]

Next, the operation of the recording/reproduction apparatus 30 having the above configuration will be described.

First, the magnetic recording cartridge 10A is loaded into the recording/reproduction apparatus 30, and the tip of the magnetic recording medium 10 is pulled out, transferred to the reel 32 via the plurality of guide rollers 35 and the head unit 36, and attached to the reel 32.

Next, when an operation unit (not shown) is operated, the spindle drive device 33 and the reel drive device 34 are driven under the control of the control device 38, and the spindle 31 and the reel 32 are caused to rotate in the same direction such that the magnetic recording medium 10 travels from the reel 10C to the reel 32. As a result, while the magnetic recording medium 10 is wound up by the reel 32, information is recorded on the magnetic recording medium 10 or information recorded on the magnetic recording medium 10 is reproduced by the head unit 36.

Further, in the case where the magnetic recording medium 10 is rewound on the reel 10C, the spindle 31 and the reel 32 are caused to be driven to rotate in the direction opposite to the above direction, thereby causing the magnetic recording medium 10 to travel from the reel 32 to the reel 10C. Also in this rewinding, information is recorded on the magnetic recording medium 10 or information recorded on the magnetic recording medium 10 is reproduced by the head unit 36.

### (6) Modified Example

### Modified Example 1

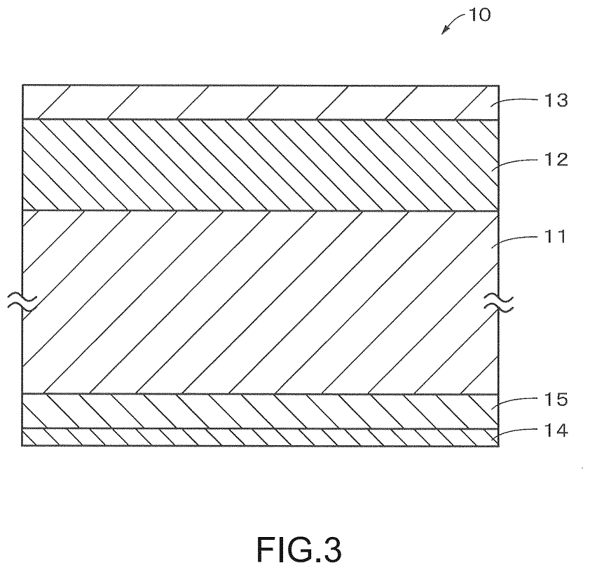

As shown in FIG. 3, the magnetic recording medium 10 may include a barrier layer 15 provided on at least one surface of the base layer 11. The barrier layer 15 is a layer for suppressing dimensional deformation of the base layer 11 depending on the environment. Examples of the cause of the dimensional deformation include hygroscopicity of the base layer 11, and the barrier layer 15 makes it possible to reduce the rate of moisture entering the base layer 11. The barrier layer 15 contains metal or metal oxide. As the metal, for example, at least one of Al, Cu, Co, Mg, Si, Ti, V, Cr, Mn, Fe, Ni, Zn, Ga, Ge, Y, Zr, Mo, Ru, Pd, Ag, Ba, Pt, Au, or Ta can be used. As the metal oxide, for example, at least one of Al₂O₃, CuO, CoO, SiO₂, Cr₂O₃, TiO₂, Ta₂Os, and Zro₂ can be used, or any of oxides of the above metals can also be used. Further, diamond-like carbon (DLC), diamond, or the like can also be used.

The average thickness of the barrier layer 15 is favorably 20 nm or more and 1,000 nm or less, more favorably 50 nm or more and 1,000 nm or less. The average thickness of the barrier layer 15 is obtained in the same manner as that for the average thickness tₘ of the magnetic layer 13. However, the magnification of the TEM image is appropriately adjusted in accordance with the thickness of the barrier layer 15.

### Modified Example 2

The magnetic recording medium 10 may be incorporated into a library apparatus. That is, the present technology also provides a library apparatus including at least one magnetic recording medium 10. The library apparatus has a configuration capable of adjusting the tension to be applied to the magnetic recording medium 10 in the longitudinal direction, and may include a plurality of recording/reproduction apparatuses 30 described above.

### Modified Example 3

The magnetic recording medium 10 may be subjected to servo signal writing processing by a servo writer. By adjusting the tension in the longitudinal direction of the magnetic recording medium 10 when the servo writer records a servo signal, for example, the width of the magnetic recording medium 10 can be kept constant or substantially constant. In this case, the servo writer may include a detection device that detects the width of the magnetic recording medium 10. The servo writer may adjust the tension in the longitudinal direction of the magnetic recording medium 10 on the basis of the detection result of the detection device.

### 3. Second Embodiment

### (1) Embodiment of Magnetic Recording Cartridge

### [Configuration of Cartridge]

The present technology also provides a magnetic recording cartridge (referred to also as a tape cartridge) that includes the magnetic recording medium according to the present technology. In the magnetic recording cartridge, the magnetic recording medium may be wound around, for example, a reel. The magnetic recording cartridge may include, for example, a communication unit that communicates with a recording/reproduction apparatus, a storage unit, and a control unit that stores, in the storage unit, information received from the recording/reproduction apparatus via the communication unit, and reads information from the storage unit and transmits the read information to the recording/reproduction apparatus via the communication unit in accordance with a request from the recording/reproduction apparatus. The information may include adjustment information for adjusting tension to be applied to the magnetic recording medium in the longitudinal direction.

An example of a configuration of the magnetic recording cartridge 10A including the magnetic recording medium T having the above-mentioned configuration will be described.

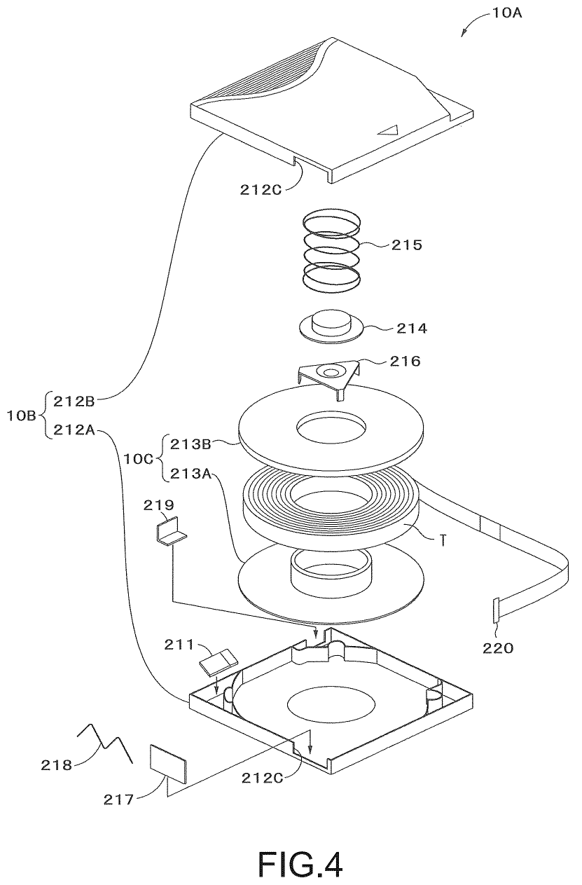

FIG. 4 is an exploded perspective view showing an example of a configuration of the magnetic recording cartridge 10A. The magnetic recording cartridge 10A is a magnetic recording cartridge conforming to the LTO (Linear Tape-Open) standard and includes, inside the cartridge case 10B including a lower shell 212A and an upper shell 212B, the reel 10C on which the magnetic tape (tape-shaped magnetic recording medium) T is wound, a reel lock 214 and a reel spring 215 for locking the rotation of the reel 10C, a spider 216 for releasing the locked state of the reel 10C, a slide door 217 for opening and closing a tape outlet 212C provided on the cartridge case 10B across the lower shell 212A and the upper shell 212B, a door spring 218 that biases the slide door 217 to the closed position of the tape outlet 212C, a write protector 219 for preventing accidental erasure, and a cartridge memory 211. The reel 10C has a substantially disk shape having an opening at its center, and includes a reel hub 213A and a flange 213B formed of a hard material such as plastics. The leader tape LT is connected to one end portion of the magnetic tape T. A leader pin 220 is provided at the tip of the leader tape LT.

The cartridge memory 211 is provided in the vicinity of one corner portion of the magnetic recording cartridge 10A. The cartridge memory 211 faces a reader/writer (not shown) of a recording/reproduction apparatus 80 while the magnetic recording cartridge 10A is loaded into the recording/reproduction apparatus 80. The cartridge memory 211 communicates with the recording/reproduction apparatus 30, specifically, a reader/writer (not shown), using a wireless communication standard conforming to the LTO standard.

### [Configuration of Cartridge Memory]

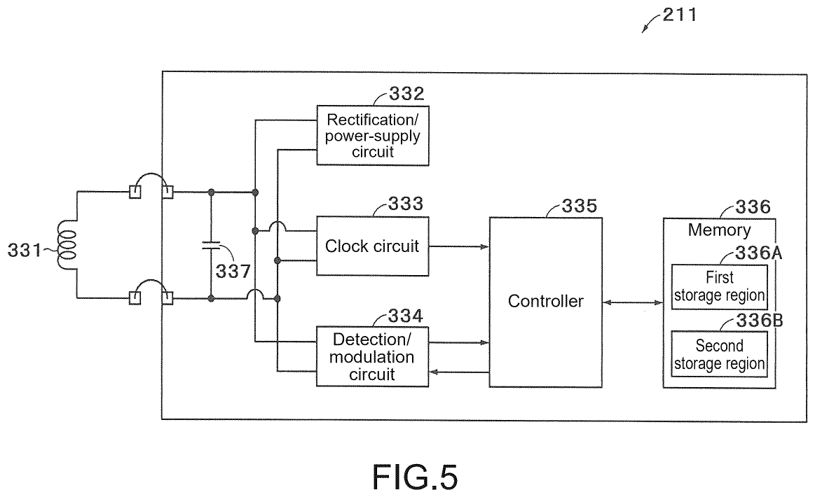

An example of a configuration of the cartridge memory 211 will be described with reference to FIG. 5.

FIG. 5 is a block diagram showing an example of a configuration of the cartridge memory 211. The cartridge memory 211 includes an antenna coil (communication unit) 331 that communicates with a reader/writer (not shown) using a predetermined communication standard, a rectification/power-supply circuit 332 that generates power from radio waves received by the antenna coil 331 using an induced electromotive force and rectifies the power to generate power supply, a clock circuit 333 that generates a clock from radio wavers received by the antenna coil 331 using an induced electromotive force similarly, a detection/modulation circuit 334 that detects radio waves received by the antenna coil 331 and modulates signals to be transmitted by the antenna coil 331, a controller (control unit) 335 that includes a logic circuit or the like for determining and processing a command and data from a digital signal extracted from the detection/modulation circuit 334, and a memory (storage unit) 336 that stores information. Further, the cartridge memory 211 includes a capacitor 337 connected in parallel to the antenna coil 331, and the antenna coil 331 and the capacitor 337 constitute a resonant circuit.

The memory 336 stores information relating to the magnetic recording cartridge 10A, and the like. The memory 336 is a non-volatile memory (NVM). The memory capacity of the memory 336 is favorably approximately 32 KB or more. For example, in the case where the magnetic recording cartridge 10A conforms to an LTO format standard in the next generation and subsequent generations, the memory 336 has the memory capacity of approximately 32 KB.

The memory 336 has a first storage region 336A and a second storage region 336B. The first storage region 336A corresponds to a storage region of a cartridge memory of the LTO standard before LTO8 (hereinafter, referred to as an “existing cartridge memory”.), and is a region for storing information conforming to the LTO standard before LTO8. Examples of the information conforming to the LTO standard before LTO8 include production information (e.g., the unique number of the magnetic recording cartridge 10A) and a usage history (e.g., the number of times the tape has been pulled out (Thread Count)).

The second storage region 336B corresponds to an extended storage region for the storage region of the existing cartridge memory. The second storage region 336B is a region for storing additional information. Here, the additional information means information relating to the magnetic recording cartridge 10A, which is not specified in the LTO standard before LTO8. Examples of the additional information include, but not limited to, tension adjustment information, management ledger data, Index information, and thumbnail information of video stored in the magnetic tape T. The tension adjustment information includes a distance between adjacent servo bands (distance between servo patterns recorded on adjacent servo bands) during data recording on the magnetic tape T. The distance between adjacent servo bands is an example of width-related information relating to the width of the magnetic tape T. The details of the distance between servo bands will be described below. In the following description, the information stored in the first storage region 336A is referred to as “first information”, and the information stored in the second storage region 336B is referred to as “second information” in some cases.

The memory 336 may include a plurality of banks. In this case, the first storage region 336A may be configured by some of the plurality of banks, and the second storage region 336B may be configured by the remaining banks. Specifically, for example, in the case where the magnetic recording cartridge 10A conforms to the LTO format standard in the next generation and subsequent generations, the memory 336 may include two banks having the memory capacity or approximately 16 KB, the first storage region 336A may be configured by one of the two banks, and the second storage region 336B may be configured by the other bank.

The antenna coil 331 induces an induced voltage by electromagnetic induction. The controller 335 communicates with the recording/reproduction apparatus 80 in a specified communication standard via the antenna coil 331. Specifically, for example, mutual authentication, transmission and reception of commands, exchanging data, and the like are performed.

The controller 335 stores the information received from the recording/reproduction apparatus 80 via the antenna coil 331 in the memory 336. The controller 335 reads the information from the memory 336 in accordance with a request from the recording/reproduction apparatus 80, and transmits the read information to the recording/reproduction apparatus 80 via the antenna coil 331.

### (2) Modified Example of Magnetic Recording Cartridge

### [Configuration of Cartridge]

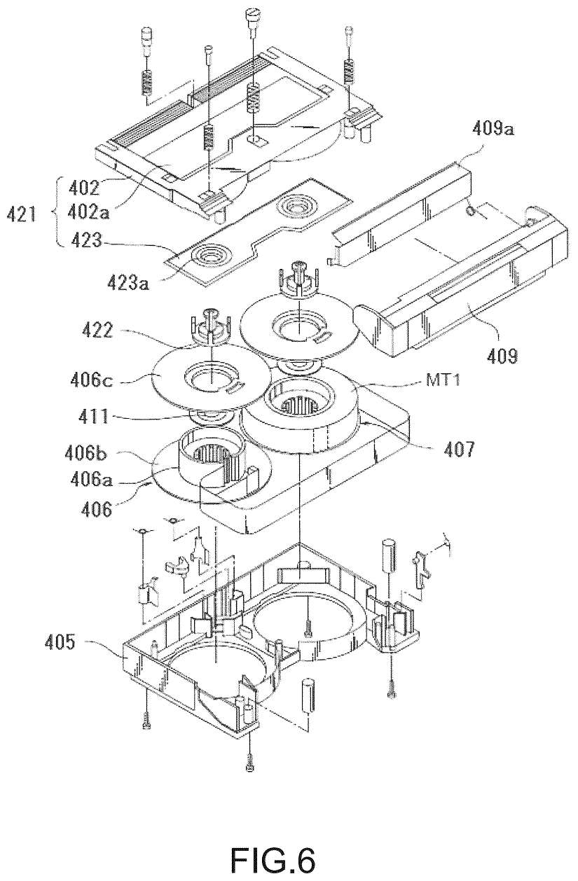

Although the case where the magnetic tape cartridge is a one-reel type cartridge has been described in the above-mentioned embodiment of the magnetic recording cartridge, the magnetic recording cartridge according to the present technology may be a two-reel type cartridge. That is, the magnetic recording cartridge according to the present technology may include one or a plurality (e.g., two) of reels by which the magnetic tape is wound up. An example of the magnetic recording cartridge according to the present technology including two reels will be described below with reference to FIG. 6.

FIG. 6 is an exploded perspective view showing an example of a configuration of a two-reel type cartridge 421. The cartridge 421 includes an upper half 402 formed of a synthetic resin, a transparent window member 423 that is fitted into and fixed to a window portion 402a that is opened on the upper surface of the upper half 402, a reel holder 422 that is fixed to the inside of the upper half 402 and prevents reels 406 and 407 from floating, a lower half 405 corresponding to the upper half 402, the reels 406 and 407 housed in the space formed by combining the upper half 402 and the lower half 405, a magnetic tape MT1 wound on the reels 406 and 407, a front lid 409 that closes a front-side opening formed by combining the upper half 402 and the lower half 405, and a back lid 409A that protects the magnetic tape MT exposed in the front-side opening.

The reel 406 includes a lower flange 406b that includes a cylindrical hub portion 406a in the center around which the magnetic tape MT1 is wound, an upper flange 406c having substantially the same size as that of the lower flange 406b, and a reel plate 411 sandwiched between the hub portion 406a and the upper flange 406c. The reel 407 has a configuration similar to that of the reel 406.

The window member 423 is provided with mounting holes 423a for assembling the reel holders 422 that are reel holding means for preventing the reels 406 and 407 from floating at the positions corresponding to these reels. The magnetic tape MT1 is similar to the magnetic tape T in the first embodiment.

It should be noted that the present technology may also take the following configurations.

[1] A magnetic recording medium having a layer structure, including:
a magnetic layer; and
a base layer, in which
the magnetic layer includes an alumina particle,
a surface roughness Rab (a measurement range: 236 μm×177 μm) is 1.70 nm or less,
an arithmetic average roughness Ra (a measurement range: 40 μm×40 μm) is 1.79 nm or less, or
a power spectrum density (PSD) value at a spatial wavelength of 5 μm or less is 3.77 nm² or less, and
an average height of a protrusion formed by the alumina particle is 0.0067 μm or less.

[2] The magnetic recording medium according to [1], in which
the magnetic layer further includes a particle having conductivity.

[3] The magnetic recording medium according to [1] or [2], in which
the surface roughness Rab (a measurement range: 236 μm×177 μm) is 1.67 nm or less.

[4] The magnetic recording medium according to any one of [1] to [3], in which
the arithmetic average roughness Ra (a measurement range: 40 μm×40 μm) is 1.73 nm or less.

[5] The magnetic recording medium according to any one of [1] to [4], in which
the power spectrum density (PSD) value at a spatial wavelength of 5 μm or less is 3.48 nm² or less.

[6] The magnetic recording medium according to any one of [1] to [5], in which
the average height of a protrusion formed by the alumina particle is 0.0060 μm or less.

[7] The magnetic recording medium according to any one of [1] to [6], in which
an average thickness of the magnetic layer is 0.09 μm or less.

[8] The magnetic recording medium according to any one of [1] to [7], further including
a non-magnetic layer.

[9] The magnetic recording medium according to [8], in which
an average thickness of the non-magnetic layer is 1.3 μm or less.

[10] The magnetic recording medium according to any one of [1] to [9], which has an average thickness (average total thickness) of 5.9 μm or less.

[11] A magnetic recording cartridge, including:
the magnetic recording medium according to any one of [1] to [10] housed in a case while being wound around a reel.

### 4. Examples

Although the present technology will be specifically described using Examples, the present technology is not limited to only these Examples.

In this Example, the surface roughness Rab, the arithmetic average roughness Ra, the power spectrum density (PSD) value at a spatial wavelength of 5 μm or less, the average height of the protrusion formed by the alumina particle, the average thickness (average total thickness) t_{T} of the magnetic tape, the average thickness tₘ of the magnetic layer, the average thickness of the non-magnetic layer (underlayer), the average thickness of the base layer, the average thickness of the back layer, and the electromagnetic conversion characteristics (SNR) are those obtained by the measurement methods described in the above-mentioned embodiment.

### Example 1

### (Process of Preparing Paint for Forming Magnetic Layer)

A paint for forming a magnetic layer was prepared as follows. First, a first composition of the following formulation was kneaded with an extruder. Next, the kneaded first composition and a second composition of the following formulation were added to a stirring tank including a dispersion device to perform preliminary mixing. Subsequently, dyno mill mixing was further performed and filter treatment was performed to prepare a paint for forming a magnetic layer.

(First composition)
Magnetic powder (barium ferrite (BaFe₁₂O₁₉), shape: hexagonal plate shape, average aspect ratio: 3.0, average particle volume: 1600 nm³): 100 parts by mass
Vinyl chloride resin (resin solution: resin content 30 mass %, cyclohexanone 70 mass %): 50 parts by mass
(degree of polymerization 300, Mn=10000, containing OSOK=0.07 mmol/g and secondary OH=0.3 mmol/g as polar groups.)
Aluminum oxide powder: 3 parts by mass
(α-Al₂O₃, average particle size of 80 nm, manufactured by Sumitomo Chemical Co., Ltd., product name: HIT82, Mohs hardness: 9)

### (Second Composition)

Carbon black: 2 parts by mass
(average particle size of 70 nm, manufactured by Tokai Carbon Co., Ltd., product name: SEAST TA)
Polyurethane resin (resin solution: blending amount of polyurethane resin 30 mass %, blending amount of cyclohexanone 70 mass %): 5.56 parts by mass
(polyurethane resin: number average molecular weight Mn=25000, Tg=110° C.)
n-butyl stearate: 2 parts by mass
Methyl ethyl ketone: 121.3 parts by mass
Toluene: 121.3 parts by mass
Cyclohexanone: 60.7 parts by mass

Finally, a polyisocyanate (product name: Coronate L, manufactured by TOSOH CORPORATION): 3.3 parts by mass and stearic acid: 2 parts by mass were added as curing agents to the paint for forming a magnetic layer prepared as described above. Note that the magnetic layer P/B ratio means the ratio of magnetic powder/adhesive (binder) and was 5.0. Hereinafter, the P/B ratio in each Example will be shown in Table 1.

### (Process of Preparing Paint for Forming Underlayer)

A paint for forming an underlayer was prepared as follows. First, a third composition of the following formulation was kneaded with an extruder. Next, the kneaded third composition and a fourth composition of the following formulation were added to a stirring tank including a dispersion device to perform preliminary mixing. Subsequently, dyno mill mixing was further performed and filter treatment was performed to prepare a paint for forming an underlayer.

### (Third Composition)

Acicular iron oxide powder: 100 parts by mass
(α-Fe₂O₃, average major axis length of 0.12 μm)
Vinyl chloride resin (resin solution: resin content 30 mass %, cyclohexanone 70 mass %): 46 parts by mass
(degree of polymerization 300, Mn=10000, containing OSOK=0.07 mmol/g and secondary OH=0.3 mmol/g as polar groups.)

### (Fourth Composition)

Carbon black: 25 parts by mass
(average particle size of 20 nm)
Polyurethane resin (resin solution: blending amount of polyurethane resin 30 mass %, blending amount of cyclohexanone 70 mass %): 36 parts by mass
(polyurethane resin: number average molecular weight Mn=25000, Tg=110° C.)
n-butyl stearate: 2 parts by mass
Methyl ethyl ketone: 108.2 parts by mass
Toluene: 108.2 parts by mass
Cyclohexanone: 18.5 parts by mass

Finaly, a polyisocyanate (product name: Coronate L, manufactured by TOSOH CORPORATION): 2.49 parts by mass and stearic acid: 2 parts by mass were added as curing agents to the paint for forming an underlayer prepared as described above.

### (Process of Preparing Paint for Forming Back Layer)

A paint for forming a back layer was prepared as follows. A paint for forming a back layer was prepared by mixing the following raw materials in a stirring tank including a dispersion apparatus and performing filter treatment thereon.
Carbon black (manufactured by ASAHI CARBON CO., LTD., product name: #80): 100 parts by mass
Polyester polyurethane: 100 parts by mass
(manufactured by Nippon Polyurethane Industry Co., Ltd., product name: N-2304)
Methyl ethyl ketone: 500 parts by mass
Toluene: 400 parts by mass
Cyclohexanone: 100 parts by mass
Polyisocyanate (product name: Coronate L, manufactured by TOSOH CORPORATION): 10 parts by mass

### (Deposition Process)

A magnetic tape was prepared as described below using the paints prepared as described above.

First, a PEN film (base film) that has a long shape and an average thickness of 4.0 μm was prepared as a support that would become a base layer of the magnetic tape. Next, a paint for forming an underlayer was applied onto one main surface of the PEN film and dried to form an underlayer on the one main surface of the PEN film such that the average thickness of the final product was 1.17 μm. Next, a paint for forming a magnetic layer was applied onto the underlayer and dried to form a magnetic layer on the underlayer such that the average thickness of the final products was 0.08 μm.

Subsequently, a paint for forming a back layer was applied onto the other main surface of the PEN film on which the underlayer and the magnetic layer were formed, and dried to form a back layer such that the average thickness of the final product was 0.50 μm. Then, curing treatment was performed on the PEN film on which the underlayer, the magnetic layer, and the back layer were formed. After that, calendaring was performed thereon to smooth the surface of the magnetic layer.

### (Cutting Process)

The magnetic tape obtained as described above was cut into a ½ inch (12.65 mm) width. In this way, a magnetic tape having a long shape was obtained.

The magnetic tape having a ½ inch width was wound around the reel provided in the cartridge case to obtain a magnetic recording cartridge. A servo signal was recorded on the magnetic tape by a servo track writer. The servo signal includes an array of magnetic patterns having the inverted V shape. Two or more arrays of the magnetic patterns were recorded in advance in parallel to the longitudinal direction at known intervals from each other (hereinafter, referred to as “known intervals between magnetic pattern arrays when recorded in advance”.).

The obtained magnetic tape had the surface roughness Rab of 1.60 nm, the arithmetic average roughness Ra of 1.56 nm, the power spectrum density (PSD) value at a spatial wavelength of 5 μm or less of 2.92 nm², the average height of the protrusion formed by the alumina particle of 0.0067 μm, the average thickness (average total thickness) t_{T} of the magnetic tape of 5.68 μm, the average thickness tₘ of the magnetic layer of 0.08 μm, the average thickness of the non-magnetic layer (underlayer) of 1.17 μm, the average thickness of the base layer of 3.94 μm, the average thickness of the back layer of 0.5 μm, and the electromagnetic conversion characteristics (SNR) of 0.97.

### Example 2

A magnetic tape was obtained in the same manner as in Example 1 except that the amount of the aluminum oxide powder added was 5 parts by mass. The obtained magnetic tape had the surface roughness Rab of 1.61 nm, the arithmetic average roughness Ra of 1.63 nm, the power spectrum density (PSD) value at a spatial wavelength of 5 μm or less of 3.21 nm², the average height of the protrusion formed by the alumina particle of 0.0067 μm, the average thickness (average total thickness) t_{T} of the magnetic tape of 5.71 μm, the average thickness tₘ of the magnetic layer of 0.08 μm, the average thickness of the non-magnetic layer (underlayer) of 1.19 μm, the average thickness of the base layer of 3.94 μm, the average thickness of the back layer of 0.49 μm, and the electromagnetic conversion characteristics (SNR) of 0.70.

### Example 3

A magnetic tape was obtained in the same manner as in Example 1 except that an aluminum oxide powder having an average particle size of 90 nm (α-Al₂O₃, average particle size of 90 nm, manufactured by Sumitomo Chemical Co., Ltd., product name: HIT70) was used and the amount of the aluminum oxide powder added was 3 parts by mass. The obtained magnetic tape had the surface roughness Rab of 1.66 nm, the arithmetic average roughness Ra of 1.73 nm, the power spectrum density (PSD) value at a spatial wavelength of 5 μm or less of 3.48 nm², the average height of the protrusion formed by the alumina particle of 0.0050 μm, the average thickness (average total thickness) t_{T} of the magnetic tape of 5.79 μm, the average thickness tₘ of the magnetic layer of 0.081 μm, the average thickness of the non-magnetic layer (underlayer) of 1.19 μm, the average thickness of the base layer of 3.99 μm, the average thickness of the back layer of 0.52 μm, and the electromagnetic conversion characteristics (SNR) of 0.69.

### Example 4

A magnetic tape was obtained in the same manner as in Example 1 except that an aluminum oxide powder having an average particle size of 140 nm (α-Al₂O₃, average particle size of 140 nm, manufactured by Sumitomo Chemical Co., Ltd., product name: HIT60A) was used and the amount of the aluminum oxide powder added was 3 parts by mass. The obtained magnetic tape had the surface roughness Rab of 1.67 nm, the arithmetic average roughness Ra of 1.63 nm, the power spectrum density (PSD) value at a spatial wavelength of 5 μm or less of 3.14 nm², the average height of the protrusion formed by the alumina particle of 0.0066 μm, the average thickness (average total thickness) t_{T} of the magnetic tape of 5.73 μm, the average thickness tₘ of the magnetic layer of 0.083 μm, the average thickness of the non-magnetic layer (underlayer) of 1.23 μm, the average thickness of the base layer of 3.94 μm, the average thickness of the back layer of 0.48 μm, and the electromagnetic conversion characteristics (SNR) of 0.69.

### Example 5

A magnetic tape was obtained in the same manner as in Example 1 except that the amount of the aluminum oxide powder added was 7.5 parts by mass. The obtained magnetic tape had the surface roughness Rab of 1.70 nm, the arithmetic average roughness Ra of 1.79 nm, the power spectrum density (PSD) value at a spatial wavelength of 5 μm or less of 3.77 nm², the average height of the protrusion formed by the alumina particle of 0.0066 μm, the average thickness (average total thickness) t_{T} of the magnetic tape of 5.73 μm, the average thickness tₘ of the magnetic layer of 0.080 μm, the average thickness of the non-magnetic layer (underlayer) of 1.17 μm, the average thickness of the base layer of 4.02 μm, the average thickness of the back layer of 0.46 μm, and the electromagnetic conversion characteristics (SNR) of 0.53.

### Example 6

A magnetic tape was obtained in the same manner as in Example 1 except that an aluminum oxide powder having an average particle size of 90 nm (α-Al₂O₃, average particle size of 90 nm, manufactured by Sumitomo Chemical Co., Ltd., product name: HIT70) was used and the amount of the aluminum oxide powder added was 5 parts by mass. The obtained magnetic tape had the surface roughness Rab of 1.68 nm, the arithmetic average roughness Ra of 1.71 nm, the power spectrum density (PSD) value at a spatial wavelength of 5 μm or less of 3.43 nm², the average height of the protrusion formed by the alumina particle of 0.0056 μm, the average thickness (average total thickness) t_{T} of the magnetic tape of 5.85 μm, the average thickness tₘ of the magnetic layer of 0.080 μm, the average thickness of the non-magnetic layer (underlayer) of 1.20 μm, the average thickness of the base layer of 4.04 μm, the average thickness of the back layer of 0.53 μm, and the electromagnetic conversion characteristics (SNR) of 0.49.

### Comparative Example 1

A magnetic tape was obtained in the same manner as in Example 1 except that an aluminum oxide powder having an average particle size of 140 nm (α-Al₂O₃, average particle size of 140 nm, manufactured by Sumitomo Chemical Co., Ltd., product name: HIT60A) was used and the amount of the aluminum oxide powder added was 7.5 parts by mass. The obtained magnetic tape had the surface roughness Rab of 1.70 nm, the arithmetic average roughness Ra of 1.79 nm, the power spectrum density (PSD) value at a spatial wavelength of 5 μm or less of 3.55 nm², the average height of the protrusion formed by the alumina particle of 0.0092 μm, the average thickness (average total thickness) t_{T} of the magnetic tape of 5.46 μm, the average thickness tₘ of the magnetic layer of 0.085 μm, the average thickness of the non-magnetic layer (underlayer) of 1.04 μm, the average thickness of the base layer of 3.87 μm, the average thickness of the back layer of 0.48 μm, and the electromagnetic conversion characteristics (SNR) of 0.25.

### Comparative Example 2

A magnetic tape was obtained in the same manner as in Example 1 except that the amount of the aluminum oxide powder added was 10 parts by mass. The obtained magnetic tape had the surface roughness Rab of 1.68 nm, the arithmetic average roughness Ra of 1.87 nm, the power spectrum density (PSD) value at a spatial wavelength of 5 μm or less of 3.78 nm², the average height of the protrusion formed by the alumina particle of 0.0078 μm, the average thickness (average total thickness) t_{T} of the magnetic tape of 5.65 μm, the average thickness tₘ of the magnetic layer of 0.081 μm, the average thickness of the non-magnetic layer (underlayer) of 1.19 μm, the average thickness of the base layer of 3.87 μm, the average thickness of the back layer of 0.50 μm, and the electromagnetic conversion characteristics (SNR) of 0.27.

### Comparative Example 3

A magnetic tape was obtained in the same manner as in Example 1 except that an aluminum oxide powder having an average particle size of 90 nm (α-Al₂O₃, average particle size of 90 nm, manufactured by Sumitomo Chemical Co., Ltd., product name: HIT70) was used and the amount of the aluminum oxide powder added was 7.5 parts by mass. The obtained magnetic tape had the surface roughness Rab of 1.65 nm, the arithmetic average roughness Ra of 1.92 nm, the power spectrum density (PSD) value at a spatial wavelength of 5 μm or less of 4.30 nm², the average height of the protrusion formed by the alumina particle of 0.0075 μm, the average thickness (average total thickness) t_{T} of the magnetic tape of 5.55 μm, the average thickness tₘ of the magnetic layer of 0.084 μm, the average thickness of the non-magnetic layer (underlayer) of 1.03 μm, the average thickness of the base layer of 3.99 μm, the average thickness of the back layer of 0.46 μm, and the electromagnetic conversion characteristics (SNR) of 0.30.

### Comparative Example 4

A magnetic tape was obtained in the same manner as in Example 1 except that an aluminum oxide powder having an average particle size of 140 nm (α-Al₂O₃, average particle size of 140 nm, manufactured by Sumitomo Chemical Co., Ltd., product name: HIT60A) was used and the amount of the aluminum oxide powder added was 5 parts by mass. The obtained magnetic tape had the surface roughness Rab of 1.77 nm, the arithmetic average roughness Ra of 1.75 nm, the power spectrum density (PSD) value at a spatial wavelength of 5 μm or less of 3.53 nm², the average height of the protrusion formed by the alumina particle of 0.0071 μm, the average thickness (average total thickness) t_{T} of the magnetic tape of 5.78 μm, the average thickness tₘ of the magnetic layer of 0.080 μm, the average thickness of the non-magnetic layer (underlayer) of 1.17 μm, the average thickness of the base layer of 3.99 μm, the average thickness of the back layer of 0.55 μm, and the electromagnetic conversion characteristics (SNR) of 0.34.

### Comparative Example 5

A magnetic tape was obtained in the same manner as in Example 1 except that an aluminum oxide powder having an average particle size of 50 nm (α-Al₂O₃, average particle size of 50 nm, manufactured by Sumitomo Chemical Co., Ltd., product name: HIT100) was used and the amount of the aluminum oxide powder added was 7.5 parts by mass. The obtained magnetic tape had the surface roughness Rab of 1.72 nm, the arithmetic average roughness Ra of 1.85 nm, the power spectrum density (PSD) value at a spatial wavelength of 5 μm or less of 4.11 nm², the average height of the protrusion formed by the alumina particle of 0.0063 μm, the average thickness (average total thickness) t_{T} of the magnetic tape of 5.44 μm, the average thickness tₘ of the magnetic layer of 0.081 μm, the average thickness of the non-magnetic layer (underlayer) of 1.03 μm, the average thickness of the base layer of 3.86 μm, the average thickness of the back layer of 0.47 μm, and the electromagnetic conversion characteristics (SNR) of 0.41.

Table 1 shows the configurations of the magnetic tapes according to Examples 1 to 6 and Comparative Examples 1 to 5 and the evaluation results.

TABLE 1

| | | | | | Alumina | Amount of | |
|---|---|---|---|---|---|---|---|
| | Surface | Arithmetic | | Alumina | particle | alumina | Magnetic |
| | roughness | average | PSD(AFM)(≤5 | protrusion | average | particle | layer |
| | Rab(VS) | roughness | μM) | height | particle | added (parts | thickness |
| | (nm) | Ra(AFM)(nm) | (nm²) | (μm) | size (nm) | by mass) | tₘ (um) |
| Example 1 | 1.60 | 1.56 | 2.92 | 0.0067 | 90 | 3 | 0.08 [symbol] |
| Example 2 | 1.61 | 1.63 | 3.21 | 0.0067 | 90 | 5 | 0.080 |
| Example 3 | 1.66 | 1.73 | 3.48 | 0.0050 | 130 | 3 | 0.08 [symbol] |
| Example 4 | 1.67 | 1.63 | 3.14 | 0.0066 | 180 | 3 | 0.083 |
| Example 5 | 1.70 | 1.79 | 3.77 | 0.0066 | 90 | 7.5 | 0.080 |
| Example 6 | 1.68 | 1.71 | 3.43 | 0.0056 | 90 | 5 | 0.080 |
| Comparative | 1.70 | 1.79 | 3.55 | 0.0092 | 180 | 7.5 | 0.085 |
| Example 1 | | | | | | | |
| Comparative | 1.68 | 1.87 | 3.78 | 0.0078 | 90 | 10 | 0.08 [symbol] |
| Example 2 | | | | | | | |
| Comparative | 1.65 | 1.92 | 4.30 | 0.0075 | 130 | 7.5 | 0.084 |
| Example 3 | | | | | | | |
| Comparative | 1.77 | 1.75 | 3.53 | 0.0071 | 180 | 5 | 0.080 |
| Example 4 | | | | | | | |
| Comparative | 1.72 | 1.85 | 4.11 | 0.0063 | 50 | 7.5 | 0.08 [symbol] |
| Example 5 | | | | | | | |

| | Underlayer | Back layer | Base layer | Total | magnetic | |
|---|---|---|---|---|---|---|
| | thickness | thickness | thickness | thickness | layer | |
| | (um) | t_{b} (um) | (um) | t_{T} (um) | P/B ratio | SNR |
| Example 1 | 1.17 | 0.50 | 3.94 | 5.68 | 5 | 0.97 |
| Example 2 | 1.19 | 0.49 | 3.94 | 5.71 | 5 | 0.70 |
| Example 3 | 1.19 | 0.52 | 3.99 | 5.79 | 5 | 0.69 |
| Example 4 | 1.23 | 0.48 | 3.94 | 5.73 | 5 | 0.69 |
| Example 5 | 1.17 | 0.46 | 4.02 | 5.73 | 5 | 0.53 |
| Example 6 | 1.20 | 0.53 | 4.04 | 5.85 | 5 | 0.49 |
| Comparative | 1.04 | 0.48 | 3.87 | 5.46 | 5 | 0.25 |
| Example 1 | | | | | | |
| Comparative | 1.19 | 0.50 | 3.87 | 5.65 | 5 | 0.27 |
| Example 2 | | | | | | |
| Comparative | 1.03 | 0.46 | 3.99 | 5.55 | 5 | 0.30 |
| Example 3 | | | | | | |
| Comparative | 1.17 | 0.55 | 3.99 | 5.78 | 5 | 0.34 |
| Example 4 | | | | | | |
| Comparative | 1.03 | 0.47 | 3.86 | 5.44 | 5 | 0.41 |
| Example 5 | | | | | | |

Note that the symbols in Table 1 mean the following measured values.
t_{T}: average thickness of magnetic tape (average total thickness) (unit: μm)
tₘ: average thickness of magnetic layer (unit: nm)
t_{b}: average thickness of back layer (unit: μm) [symbol]
indicates data missing or illegible when filed

The following can be seen from the results shown in Table 1.

Each of the magnetic tapes according to Examples 1 to 6 had the surface roughness Rab of 1.70 nm or less, the arithmetic average roughness Ra of 1.79 nm or less, the power spectrum density (PSD) value at a spatial wavelength of 5 μm or less of 3.77 nm² or less, the average height of the protrusion formed by the alumina particle of 0.0067 μm or less, and excellent electromagnetic conversion characteristics.

When comparing Example 1 and Comparative Example 1 with each other, the magnetic tape according to Example 1 had the average height of the protrusion formed by the alumina particle of 0.0067 μm or less and excellent electromagnetic conversion characteristics. On the other hand, the magnetic tape according to Comparative Example 1 had the average height of the protrusion formed by the alumina particle greater than 0.0067 μm and was inferior in electromagnetic conversion characteristics to Example 1.

Further, when comparing Example 1 and Comparative Example 2 with each other, the magnetic tape according to Example 1 had the arithmetic average roughness Ra of 1.79 nm or less, the power spectrum density (PSD) value at a spatial wavelength of 5 μm or less of 3.77 nm² or less, the average height of the protrusion formed by the alumina particle of 0.0067 μm or less, and excellent electromagnetic conversion characteristics. On the other hand, the magnetic tape according to Comparative Example 2 had the arithmetic average roughness Ra greater than 1.79 nm, the power spectrum density (PSD) value at a spatial wavelength of 5 μm or less greater than 3.77 nm², the average height of the protrusion formed by the alumina particle greater than 0.0067 μm, and poor electromagnetic conversion characteristics.

Further, when comparing Example 1 and Comparative Example 3 with each other, the magnetic tape according to Example 1 had the arithmetic average roughness Ra of 1.79 nm or less, the power spectrum density (PSD) value at a spatial wavelength of 5 μm or less of 3.77 nm² or less, the average height of the protrusion formed by the alumina particle of 0.0067 μm or less, and excellent electromagnetic conversion characteristics. On the other hand, the magnetic tape according to Comparative Example 3 had the arithmetic average roughness Ra greater than 1.79 nm, the power spectrum density (PSD) value at a spatial wavelength of 5 μm or less greater than 3.77 nm², the average height of the protrusion formed by the alumina particle greater than 0.0067 μm, and poor electromagnetic conversion characteristics.

Further, when comparing Example 1 and Comparative Example 4 with each other, the magnetic tape according to Example 1 had the surface roughness Rab of 1.70 nm or less, the average height of the protrusion formed by the alumina particle of 0.0067 μm or less, and excellent electromagnetic conversion characteristics. Meanwhile, the magnetic tape according to Comparative Example 4 had the surface roughness Rab greater than 1.70 nm, the average height of the protrusion formed by the alumina particle greater than 0.0067 μm, and poor electromagnetic conversion characteristics.

Further, when comparing Example 1 and Comparative Example 5 with each other, the magnetic tape according to Example 1 had the surface roughness Rab of 1.70 nm or less, the arithmetic average roughness Ra of 1.79 nm or less, the power spectrum density (PSD) value at a spatial wavelength of 5 μm or less of 3.77 nm² or less, and excellent electromagnetic conversion characteristics. On the other hand, the magnetic tape according to Comparative Example 5 had the surface roughness Rab greater than 1.70 nm, the arithmetic average roughness Ra greater than 1.79 nm, the power spectrum density (PSD) value at a spatial wavelength of 5 μm or less greater than 3.77 nm², and poor electromagnetic conversion characteristics.

Although embodiments and Examples of the present technology have been specifically described, the present technology is not limited to the above-mentioned embodiments and Examples, and various modifications based on the technical idea of the present technology can be made.

For example, the configurations, methods, processes, shapes, materials, numerical values, and the like mentioned in the above-mentioned embodiments and Examples are merely examples, and configurations, methods, processes, shapes, materials, numerical values, and the like different from these may also be used as necessary. Further, the chemical formulae of compounds and the like are representative ones, and they are not limited to the stated valances and the like as long as they are general names of the same compounds.

Further, the configurations, methods, processes, shapes, materials, numerical values, and the like in the above-mentioned embodiments and Examples can be combined with each other without departing from the essence of the present technology.

Further, in the present specification, the numerical range indicated using “to” indicates a range that respectively includes numerical values written before and after “to” as the minimum value and the maximum value. In the numerical ranges described in a stepwise manner in the present specification, the upper limit value or the lower limit value of the numerical range in one step may be replaced with the upper limit value or the lower limit value of the numerical range in another step. Unless otherwise specified, one of the materials exemplified in the present specification can be used alone, or two or more of them can be used in combination.

### REFERENCE SIGNS LIST

10 magnetic recording medium
11 base layer
12 underlayer
13 magnetic layer
14 back layer

1. A magnetic recording medium having a layer structure, comprising:
a magnetic layer; and
a base layer, wherein
the magnetic layer includes an alumina particle,
a surface roughness Rab (a measurement range: 236 μm×177 μm) is 1.70 nm or less,
an arithmetic average roughness Ra (a measurement range: 40 μm×40 μm) is 1.79 nm or less, or
a power spectrum density (PSD) value at a spatial wavelength of 5 μm or less is 3.77 nm² or less, and
an average height of a protrusion formed by the alumina particle is 0.0067 μm or less.

2. The magnetic recording medium according to claim 1, wherein
the magnetic layer further includes a particle having conductivity.

3. The magnetic recording medium according to claim 1, wherein
the surface roughness Rab (a measurement range: 236 μm×177 μm) is 1.67 nm or less.

4. The magnetic recording medium according to claim 1, wherein
the arithmetic average roughness Ra (a measurement range: 40 μm×40 μm) is 1.73 nm or less.

5. The magnetic recording medium according to claim 1, wherein
the power spectrum density (PSD) value at a spatial wavelength of 5 μm or less is 3.48 nm² or less.

6. The magnetic recording medium according to claim 1, wherein
the average height of a protrusion formed by the alumina particle is 0.0060 μm or less.

7. The magnetic recording medium according to claim 1, wherein
an average thickness of the magnetic layer is 0.09 μm or less.

8. The magnetic recording medium according to claim 1, further comprising
a non-magnetic layer.

9. The magnetic recording medium according to claim 8, wherein
an average thickness of the non-magnetic layer is 1.3 μm or less.

10. The magnetic recording medium according to claim 1, which has an average thickness (average total thickness) of 5.9 μm or less.

11. A magnetic recording cartridge, comprising:
the magnetic recording medium according to claim 1 housed in a case while being wound around a reel.
